(19) United States
(12) Patent Application Publication
(10) Pub. No.: US 2011/0250020 A1
(43) Pub. Date: Oct. 13, 2011

(54) DEVICES AND METHODS FOR TRENCHLESS REPLACEMENT OF UNDERGROUND PIPE

(76) Inventors: Robert Ward Carter, Lafayette, CA (US); Frank Geshwind, Madison, CT (US); Nicolae Neag, Toronto (CA)

(21) Appl. No.: 12/673,976

(22) PCT Filed: Aug. 18, 2008
(86) PCT No.: PCT/US08/73531

§ 371 Date: Jul. 5, 2011

Related U.S. Application Data
(60) Provisional application No. 60/956,672, filed on Aug. 17, 2007.

(51) Int. Cl. F16L 55/18; F16L 1/028

(52) U.S. Cl. 405/184.3

(57) ABSTRACT

An embodiment of the invention comprises a pipe parting mole, a length of cable that is engagable to the mole, a cable pulling device and a cable pulling device engagement frame that provides a mounting structure for the cable pulling device. The cable pulling device engagement frame comprises a reaction plate and an annulus member for removably engaging the cable pulling device with the frame. The frame is configured for the sideways engagement of the cable within the frame and the annulus member. Two pairs of cable engagement collets are preferably utilized; a first pair being disposed within the cable pulling device to engage the cable on a pulling stroke, and a second pair may be disposed within the frame or the cable pulling device to engage the cable on a recovery stroke. In an embodiment the cable pulling device comprises a post tensioning ram (PTR).

### CROSS-REFERENCE TO RELATED APPLICATIONS

The present invention claims priority to U.S. Provisional Patent Application Ser. No. 60/956,672, filed Aug. 17, 2007, which is incorporated herein by reference in it's entirety.

### BACKGROUND OF THE INVENTION

1. Field of the Invention

The present invention relates generally to devices and methods for the trenchless replacement of underground pipes and more particularly to pipe splitting devices and cable pulling devices and methods for splitting and expanding existing pipe to facilitate the replacement thereof with new pipe.

2. Description of the Prior Art and Background

Trenchless technology for the replacement of underground pipe is not new, and the standard equipment and methods generally used are well known. This standard equipment for this technology is very large, heavy, and therefore requires additional large, heavy duty equipment for the transportation to, and the placement thereof on site, and the operation thereof on site.

There are several methods of propelling a pipe bursting, and/or cracking and expanding device, and pulling a new pipe through an existing pipe. The most commonly used methods are large cable winches, and/or rod pushers or pullers that are usually hydraulically powered, and often used with a pneumatic percussive device helping to drive the pipe breaking device. Winches give continuous motion during pulling, while rod pushers/pullers generally give cycled motion in which they pull, then a rod must be either added or removed, before the return stroke, and next pull stroke. Sometimes rod pushers are converted to cable pullers, eliminating the need for rod removal.

Winches and rod pushers/pullers that can produce pulling forces of up to 75 tons can themselves weigh 2 to 5 tons and must be handled and placed in position to pull; they are powered by correspondingly heavy duty equipment, cranes, trucks, and back-hoes, etc. They also need large excavations, such that the support equipment can take up enough room so as to create traffic problems and even require street closures.

This also means that only large companies with large financial resources can afford the equipment necessary to replace underground pipes, and because the costs and maintenance on this equipment can be high, their prices are also high. Therefore the use of this prior art trenchless technology has been limited mainly to the 6 inch or above size pipe of municipal or corporate supply and sewer lines, and is used mainly by large contractors.

Aspects of the present invention relate to impactors and piercing tools. Embodiments in this regards can be comprised of a piercing tool such as the piercing tools described in U.S. Pat. No. 5,025,868 to Wentworth et. al., which is incorporated herein by reference.

### SUMMARY OF THE INVENTION

An embodiment of the invention is comprised of a pipe parting mole, a length of cable that is engagable to the mole, a cable pulling device and a cable pulling device engagement means that provides a mounting structure for the cable pulling device. The cable pulling device engagement means generally includes a reaction plate and a structure for removably engaging the cable pulling device therewithin. A cable pulling frame may be advantageously used to facilitate the removal of the cable from a relatively small hole that is created at the pulling end of the pipe.

The equipment of this invention, is of modular design and needs no bolting, or tools to assemble. It will fit into an excavation hole that is 2 feet wide and 3.5 feet long, for the small pullers (24 tons) and 2′.times.4.5 feet long for the largest puller (75+ tons) the entrance hole for the replacement pipe need be only as long as the radius bend, that the polyethylene pipe size used, requires.

The components of the present invention can be easily built in several sizes according to the strength of the cable to be pulled, and componentized, so that no component weighs more than 75 lbs. One can now move all the equipment necessary to pull up to 150,000 pounds (75 tons), in one average sized pick-up truck and hand carry it to remote areas normally inaccessible to the larger prior art equipment. The present invention has particular applications in the vast 4″ diameter home lateral pipe field, which has, up to now been relatively untouched by the trenchless method of pipe replacement.

These and other features and advantages of the present invention will be well understood by those of ordinary skill in the art upon reading the following detailed description of the preferred embodiment.

### IN THE DRAWINGS

FIG. 1 is a side elevational view depicting the utilization of the present invention in a trenchless replacement operation;

FIG. 2 is a side elevational view of a first pipe splitting device or mole of the present invention;

FIG. 3 is an end elevational view of the mole depicted in FIG. 2;

FIG. 4 is a side elevational view of an alternative mole of the present invention;

FIG. 5 is an end elevational view of the mole depicted in FIG. 4;

FIG. 6 is a side elevational view of a four legged cable pulling frame of the present invention;

FIG. 7 is an end elevational view of the cable pulling frame depicted in FIG. 6;

FIG. 8 is a side elevational view of a frame mounting plate of the present invention;

FIG. 9 is a side elevational view of a cable pulling device of the present invention;

FIG. 10 is an enlarged view of the cable engaging collet of the cable puller depicted in FIG. 9;

FIG. 11 is a perspective view depicting the insertion of the cable pulling device nose piece within an annulus member;

FIG. 12 is a side elevational view of a three-legged mounting frame of the present invention;

FIG. 13 is an end elevational view of the mounting frame depicted in FIG. 12;

FIG. 14 is a side elevational view of another mounting frame embodiment of the present invention;

FIG. 15 is an end elevational view of the mounting frame depicted in FIG. 14;

FIG. 16 is an exploded perspective view of a further cable pulling device mounting system of the present invention;

FIG. 17 is an end elevational view of the annulus member depicted in FIG. 16;

FIG. 18 is a side elevational view of the annulus member depicted in FIG. 17;

FIG. 19 is a side elevational view of an alternative mole embodiment of the present invention;

FIG. 20 is an end elevational view of the mole depicted in FIG. 19;

FIG. 21 is a side elevational view of the mole depicted in FIG. 19 where the blade is engaged with a seal;

FIG. 22 is a side elevational view of yet another mole design of the present invention;

FIG. 23 is a side elevational view of the mole blade depicted in FIG. 22;

FIG. 24 is a side cross-sectional view of a mole, depicting a cable engagement fixture of the present invention;

FIG. 25 is a side cross-sectional view of a replacement pipe engagement system of the present invention;

FIG. 26 is a perspective view of a replacement pipe engagement sleeve utilized in the replacement pipe engagement method depicted in FIG. 25;

FIG. 27 is a side cross-sectional view depicting another replacement pipe engagement system of the present invention;

FIG. 28 is a side elevational view of a cable pulling device of the present invention having two sets of collets;

FIG. 29 is a perspective view of a set of collets utilized in the cable pulling device depicted in FIG. 28;

FIG. 30 is a perspective view of yet another cable pulling frame, being adapted for the engagement of two cable pulling devices and two pulling cables;

FIG. 31 is an end elevational view of the device depicted in FIG. 30;

FIG. 32 is a side elevational view of the device depicted in FIG. 30; and

FIG. 33 is a top plan view of the device depicted in FIG. 30.

FIG. 34 is an elevational view of a cable pulling device of the present invention;

FIG. 35 is an exploded perspective view of the device depicted in FIG. 34.

FIG. 36 is a perspective view of a bottom fixture that comprises a portion of the device depicted in FIG. 34.

FIG. 37 is a perspective view of a top fixture that comprises a portion of the device depicted in FIG. 34.

FIG. 38 is a perspective view of a hydraulic cylinder that comprises a portion of the device depicted in FIG. 34.

FIG. 39 is an exploded perspective view of the hydraulic cylinder depicted in FIG. 38.

FIG. 40 is a perspective view of a nose piece that comprises a portion of the device depicted in FIG. 34.

FIG. 41 depicts an embodiment of a power spool for use in the trenchless replacement of underground pipe in accordance with the present invention.

FIG. 42 depicts a combined puller and impactor for use in the trenchless replacement of underground pipe in accordance with the present invention.

FIG. 43-45 depict additional views and variations of the mole and impactor of FIG. 42.

FIG. 46 shows a partial break-away view of the mole and impactor of FIGS. 42-45, together with an upsizing accessory

FIG. 47-50 show aspects of the use of the combined puller and impactor system of FIGS. 42-46.

FIGS. 51 and 51A show an additional embodiment of a mole and impactor in accordance with the present invention

FIG. 52 shows an additional embodiment in accordance with the present invention, of a puller with 4 hydraulic cylinders, and with singe-moving-side grippers.

FIG. 53-54 show addition details of the single-moving-side grippers in accordance with the present invention

FIG. 55 depicts an embodiment of a multi-roller pulley, frame and reaction plate assembly in accordance with the present invention.

### DETAILED DESCRIPTION OF THE PREFERRED EMBODIMENTS

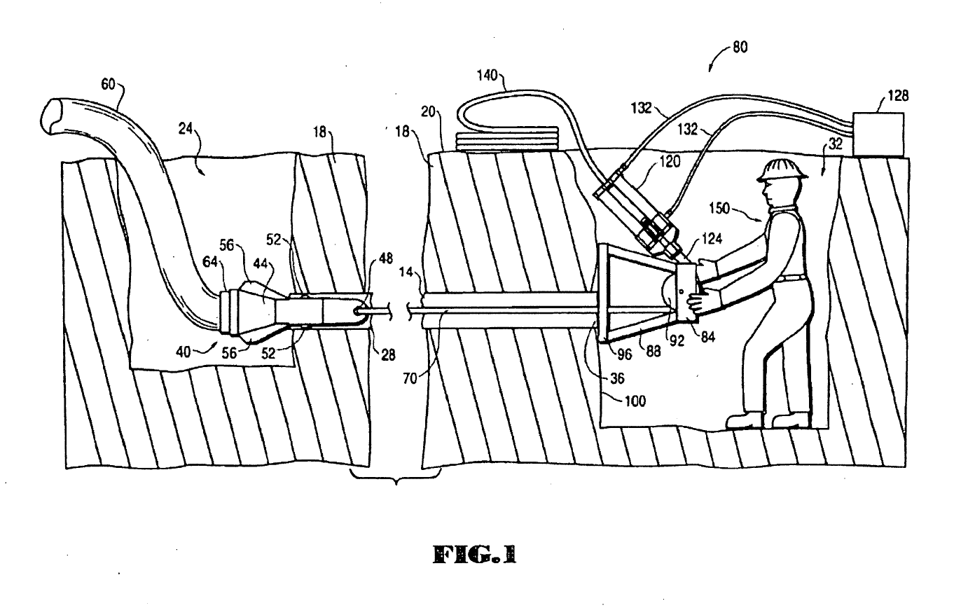

FIG. 1 is a side elevational view depicting the use of the trenchless pipe replacement device of the present invention. As depicted therein, an existing pipe 14 that is being replaced is disposed within earth 18 beneath the ground level surface 20. A first hole 24 has been dug to reveal a first end 28 of the pipe 14, and a second hole 32 has been dug to reveal a second end 36 of the pipe 14. A pipe parting and expanding device 40 referred to herein as a mole, is inserted within the first pipe end 28. The mole 40 includes a generally tapered body portion 44, a nose portion 48, one or more pipe scoring wheels 52 and one or more pipe parting fins or blades 56 disposed along the body portion 44. A length of replacement pipe 60 is removably engaged to the rearward end 64 of the body portion 44 of the mole 40. A detailed description of the mole 40 is presented herebelow.

A mole pulling cable 70 is passed from the second end of the pipe 36, through the pipe 14 to a pinned engagement with the nose 48 of the mole 40. The cable 70 is utilized to pull the mole 40 through the pipe 14, parting and enlarging the pipe 14 as it is pulled therethrough. The replacement pipe 60 is pulled behind the mole 40, such that when the mole 40 has been pulled entirely through the pipe 14, the replacement pipe 60 will reside in place within the parted, expanded pipe 14 to functionally replace it.

A light weight cable pulling system, generally designated 80, is disposed within the second hole 32 proximate the second end 36 of the pipe 14. The preferred cable pulling system 80 includes a cable pulling frame member 84 having leg members 88 and a rotatable cable pulley 92 mounted thereto. A frame bracing reaction plate 96 is positioned against the side wall 100 of the hole 32 to provide a strong, firm surface for reactive cable pulling forces, as described herebelow. The reaction plate 96 is formed with a cable passage slot 104 (not shown in FIG. 1) for passage of the cable 70 therethrough. The cable 70 therefore passes through the plate slot 104 and around the cable pulley 92 to a cable pulling device 120 that is next described.

The cable pulling device 120 is removably mounted to a generally cylindrical, slotted mounting socket or annulus 124 that is fixedly engaged to the frame 84. The cable pulling device 20 is preferably a hydraulic device which is operated utilizing a portable hydraulic pump 128 having hydraulic lines 132 leading therefrom to the cable pulling device 120. The cable pulling device 120 includes a cable pulling collet which releasably engages the cable for repeatable short pulling strokes. End portions of the cable 70 may be disposed in a coil 140 upon the ground surface 20.

It is therefore to be understood that an operator 150, having engaged the cable 70 to the mole 40, will pass the cable through the plate slot 104, around the pulley 92 into the slotted annulus 124 and into operative engagement within the cable puller 120 that is mounted in the socket 124. Thereafter, the operator 150 will activate the pump 128 and then activate the cable puller 120 to complete a first cable pulling stroke of perhaps 3 to 6 inches depending upon the travel of the hydraulic pulling device 120, as is discussed in greater detail herebelow. Repeated pulling strokes of the puller 120 ultimately pulls the mole 40 entirely through the pipe 14, until the mole 40 protrudes past the second end 36 of the pipe 14, whereupon the replacement pipe 60 has been pulled entirely through the parted, expanded pipe 14, in operational replacement thereof. The mole 40 is then disengaged from the replacement pipe 60. The cable pulling system 80 is then removed from the hole 32, appropriate pipe fixturing and jointing is accomplished at both ends of the replacement pipe, and the holes 24 and 32 can then be refilled.

It is therefore to be understood that the modular, light weight, pipe replacement system of the present invention allows a single worker to easily take all steps necessary to accomplish the replacement of a length of buried, pre-existing pipe. The various components of the system, the mole 40, the replacement pipe 60, the cable 70, the plate 96, the frame 92, the cable pulling device 120 and the pump 128 are all compact, light weight components that can be easily transported in a light duty pickup truck, and hand carried to, placed and assembled into the pulling hole by one man.

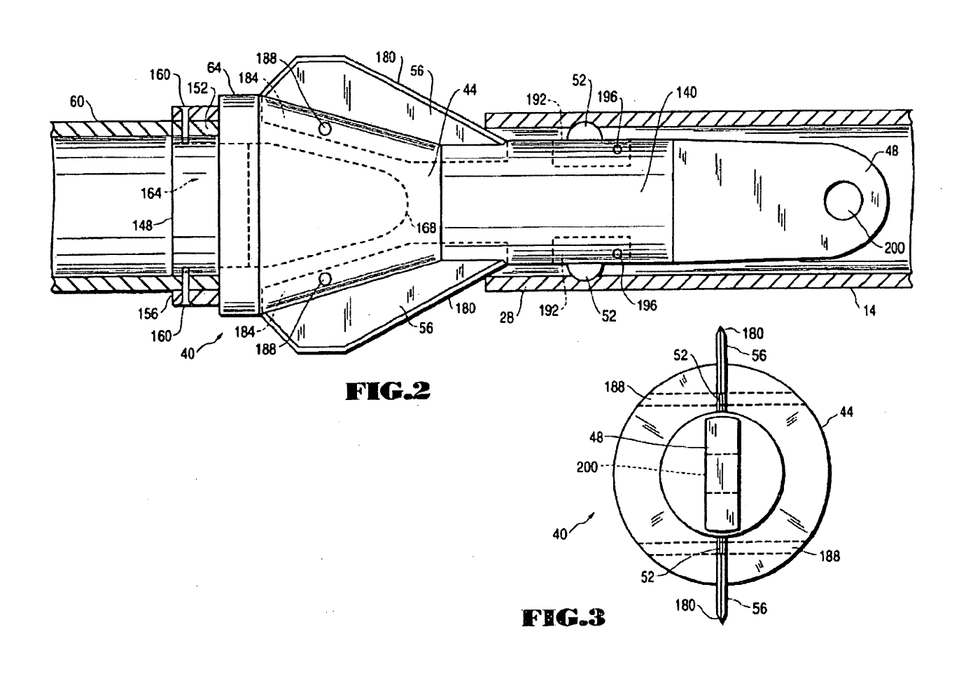

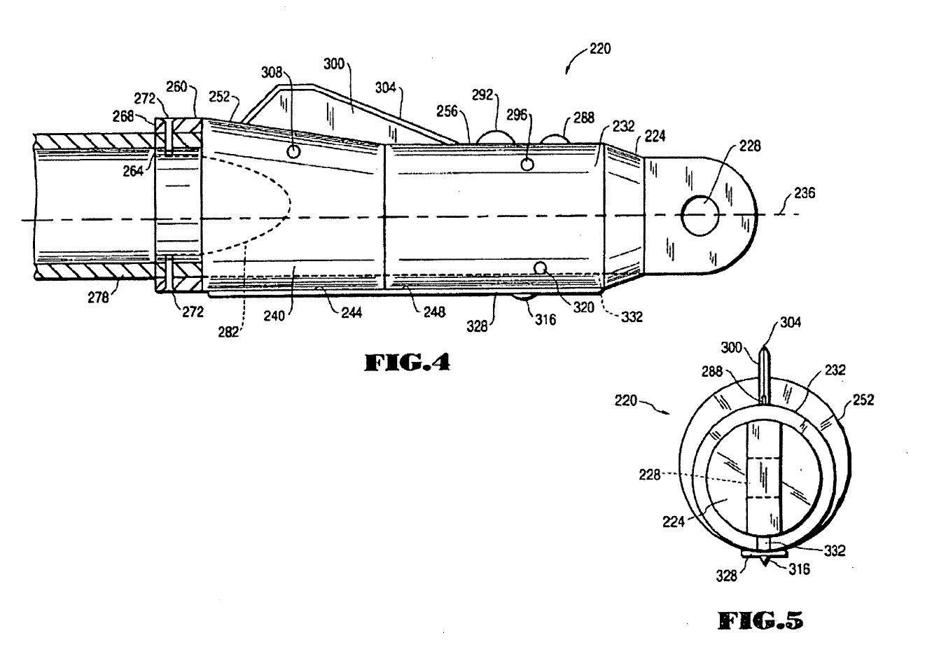

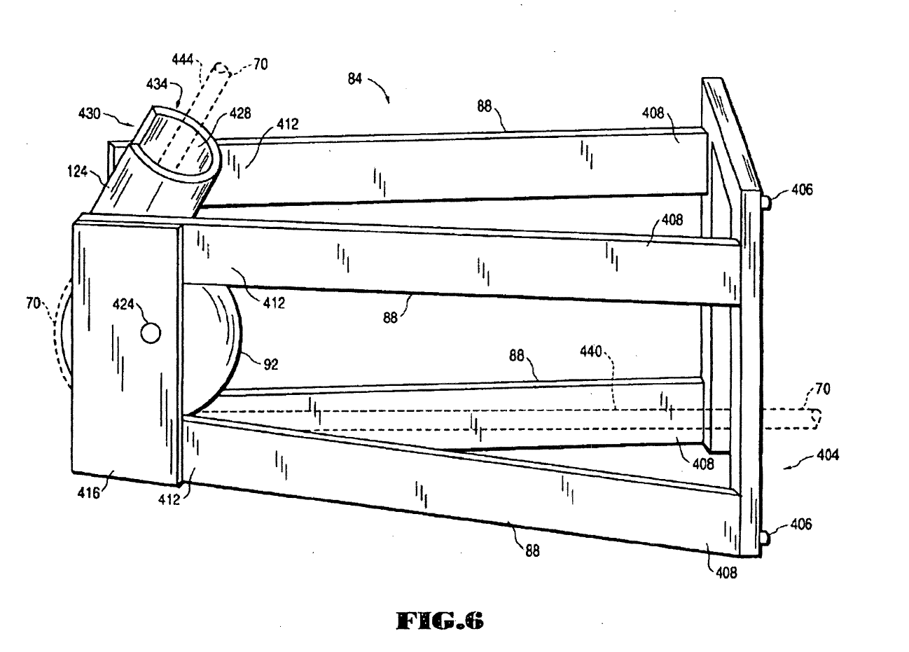

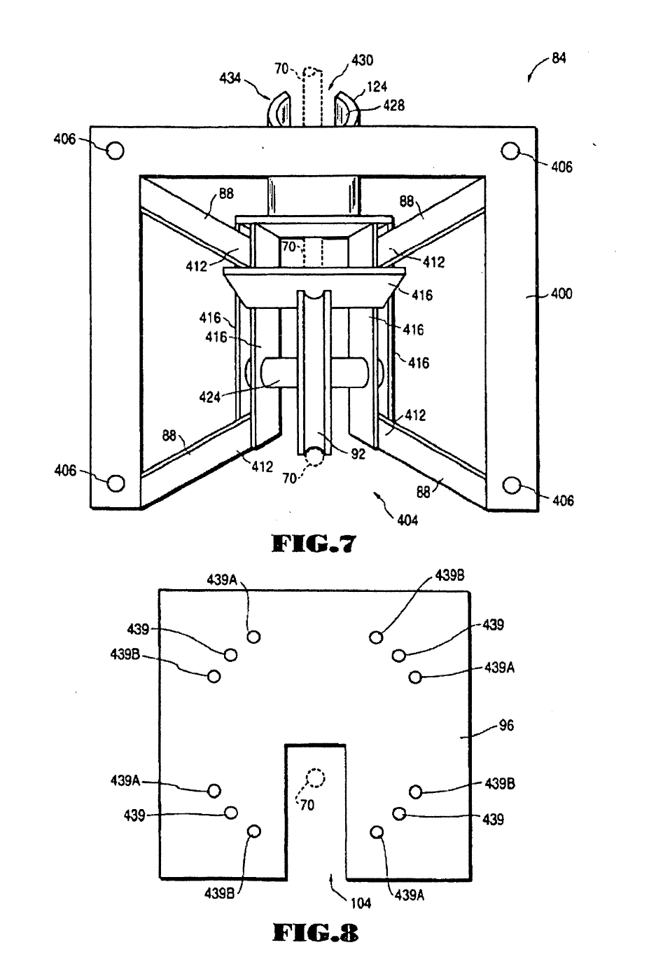

A first preferred mole of the present invention is depicted in FIGS. 2 and 3, wherein FIG. 2 is a side elevational view and FIG. 3 is an end view taken from the nose 48 of the mole 40. Components of the mole previously identified are numbered identically. As depicted in FIGS. 2 and 3, the mole 40 includes a generally tapered nose portion 48, having a cable engagement bore 136 formed therethrough. The mole 40 further includes a generally cylindrical center portion 140, the tapered body portion 44, and the rear portion 64 which includes an integrally formed, rearwardly projecting cylindrical replacement pipe attachment shoulder 148. As is best seen in FIG. 2, the end 152 of the length of replacement pipe 60 fits over the shoulder 148 and a cylindrical pipe retaining sleeve 156 is placed outside of the pipe end 152. A plurality of pipe engagement screws 160 which project through the sleeve 156 and through holes formed in the end 152 of the pipe 60, are threadably engaged within the rearwardly projecting shoulder 148. Through use of the sleeve 156 and screws 160, the end 152 of the pipe 60 is removably engaged to the rearward portion 64 of the mole 40. A bore 164 is preferably formed within the rearward end 64 of the mole 40. The bore 164 has inwardly tapered sidewalls 168 for a mating engagement with a tapered forward end of a standard impact driver (not shown). The use of such an impact driver to percussively drive a mole forward into a pipe is well known in the prior art. The inventors have found that the use of an impact driver is not necessary to part and replace ordinary lengths of pipe. However, where the pipe includes various types of clamps and joints that can strengthen the pipe at the location of such clamps and joints, the use of an impact driver to aid in moving the mole 40 through the pipe, may be beneficial.

The pipe parting blades 56 are preferably disposed within a blade holding slot 184 formed in the tapered body 44 and cylindrical section 140 of the mole 40, and blade retaining pins 188 are disposed in retaining pin bores formed through the tapered portion 44 and the inner portions of the blades 56. The blades 56 are preferably formed of a hardened steel and are sharpened on the outer edge 180 to facilitate the pipe parting function of the blades 56.

The pipe scoring wheels 52 are preferably engaged in a scoring wheel holding member that is disposed within a scoring wheel slot 192 cut into the cylindrical portion 140 of the mole 40, and retaining pins 196 which project through retaining pin bores are utilized to hold the scoring wheel mechanisms in place. It is therefore to be understood that both the scoring wheels 52 and the blades 56 are removably engagable with the mole 40, such that they can be easily replaced when it is necessary to do so.

An alternative mole 220 is depicted in FIGS. 4 and 5, wherein FIG. 4 is a side elevational view and FIG. 5 is an end elevational view. The mole 220 includes a tapered nose portion 224 having a cable engagement bore 228 formed therethrough. A generally cylindrical body portion 232 having a central axis 236 is integrally formed with the nose portion 224. A non-concentrically tapered body portion 240 is formed rearwardly of the cylindrical portion 232. The tapered portion 240 is excentrically formed such that one external surface 244 is a straight line extension of the cylindrical surface 248 of the cylindrical portion 232. The opposite surface 252 of the tapered portion 240 is flared outwardly relative to the surface 256 of the cylindrical portion 232. It is therefore to be understood that the surfaces 244, 248 and 256 are parallel to the center line 236, whereas the surface 252 diverges from the center line 236 toward the rearward portions of the mole 220.

A rearward portion 260 of the mole 220 includes a rearwardly extending replacement pipe engagement shoulder 264 and a pipe engagement sleeve 268, which together cooperate with pipe retaining screws 272 to hold a leading edge of a section of replacement pipe 278. A generally tapered impact driver bore 282 is preferably formed in the rearward end 260 of the mole 220 to provide a mating engagement with a tapered nose portion of an impact driver (not shown), as has been described hereabove with regard to mole 40, depicted in FIGS. 2 and 3. A pair of pipe scoring wheels 288 and 292 are disposed in a scoring wheel retaining mechanism that is held in place by a pin 296. The pipe scoring wheels 288 and 292 are preferably arranged such that the first wheel 288 scores the pipe a first distance into its interior wall, and the second scoring wheel 292 scores the pipe in the same track an additional distance into the interior wall of the pipe to facilitate the parting of the pipe. A pipe parting blade 300 having a sharpened edge 304 is disposed within the tapered side 252 of the mole 220 to part the pipe along the line scored by the wheels 288 and 292. A blade retaining pin 308 facilitates the replaceable engagement of the blade 300 with the mole 220. In the preferred embodiment, another pipe scoring wheel 316 is disposed on the straight, opposite side of the mole 220 from the two scoring wheels 288 and 292. The pipe scoring wheel 316 is replaceably engaged utilizing a wheel retaining pin 320 in the manner previously described herein. Additionally, a hardened steel skid plate 328 is engaged to the straight side of the mole 220 utilizing an engagement slot 332 that is formed axially into the lower surface of the mole 220. The scoring wheel 316 further facilitates the parting of the pipe when it is expanded by the non-concentric tapered portion 240, and the hardened steel skid plate 328 provides a longer useful lifetime to the mole 220. A cable pulling frame 84 is next described.

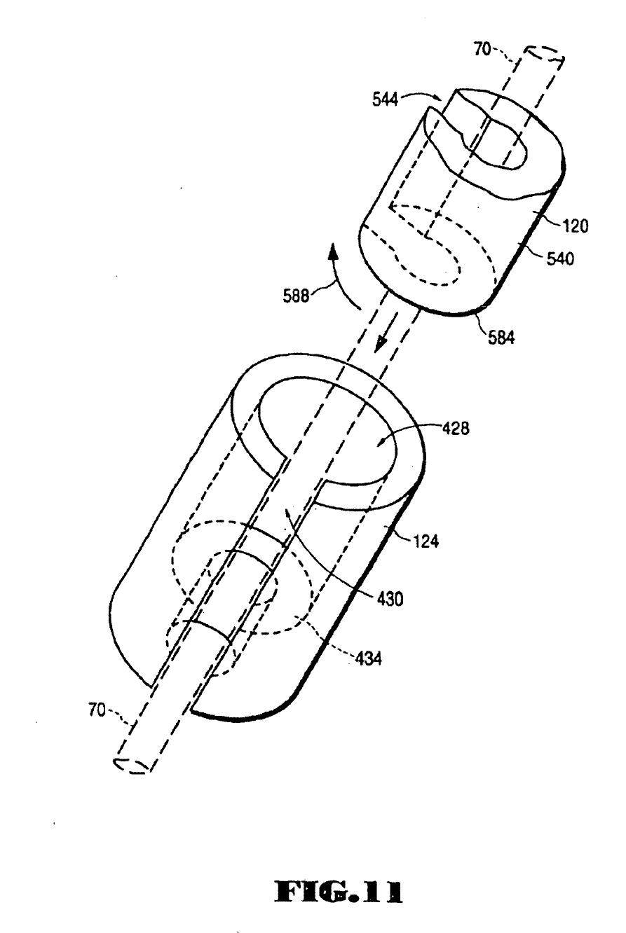

The cable pulling frame 84 as depicted in FIGS. 6 and 7, includes a generally U-shaped base member 400 which is preferably made from three pieces of rectangular steel stock that are welded together at their ends. Significantly, a fourth frame member that would create a square base is omitted, such that a gap 404 is provided. The gap 404 facilitates the placement of the frame 84 onto an existing length of cable 70 that projects outwardly from the end 36 of the pipe 14. A plurality of reaction plate alignment pins 406 project from the base member 400 for the aligned engagement of the frame 84 with the reaction plate 96, as is described hereinbelow. An inner end 408 of each of the leg members 88 is engaged, such as by welding, to a corner of the U-shaped base member 400 to create a stable frame structure. The outer ends 412 of the leg members 88 are engaged together by frame members 416, such as by welding, to form a strong stable structure. The leg members 88 and frame members 416 are preferably made from rectangular, tubular steel stock. The cable pulley 92 is rotatably mounted to an axle 424 that is engaged to the frame members 416. The annulus 124 is a generally cylindrical tubular member having a cable passage bore 428 formed therethrough, and an outer portion of its sidewall is removed to form a cable passage slot 430. The slot 430 functions such that the cable 70 may be placed into bore 428 of the annulus 124 from its side through the slot 430; whereby it is not necessary to thread the end of the cable through the annulus 124. As is best seen in FIG. 11 and described in detail hereinbelow, a mounting shoulder 434 projects into the slotted bore 428 of the annulus 124 to facilitate the removable mounting of the cable pulling device 120 therewithin.

The frame bracing reaction plate 96 of the present invention is depicted in FIG. 8. The reaction plate is a generally rectangular or square flat member that is preferably formed from a strong, light weight metal, such as an aluminum alloy. The reaction plate serves to provide a firm footing for the base member 400 of the cable pulling frame 84; thus, the plate 96 is formed with a sufficient thickness to reactively withstand the cable pulling forces that the frame 84 places against the wall 100 of the pipe access hole 32. A cable passage slot 104 is formed from a side of the plate 96 towards its center. The slot 104 permits the plate 96 to be installed around cable 70 that is already engaged to a mole 40 and projects outwardly through the end 36 of a pipe 14. A plurality of frame engagement holes 439 are formed in the plate 96 to matingly engage the base plate alignment pins 406 of the cable pulling frame 84 for the aligned engagement of the frame 84 with the base plate 96. In the field it is not always possible to place the reaction plate 96 in a preferred, vertical manner as depicted in FIG. 8, and it may be necessary to place the reaction plate in a rotated manner. It would, however, still be desirable to place the mounting frame in a generally vertical orientation. To achieve this, additional sets of mounting holes 439A and 439B are advantageously formed in the reaction plate 96 to provide rotated mounting hole configurations into which the mounting pins 406 can be inserted to achieve a more nearly vertical mounting of the frame 84 with a rotated reaction plate 96.

It is to be understood that a significant feature of the frame member 84 is that a mole-attached cable 70 can be wrapped around the pulley 92, such that the interior portion 440 of the cable 70 projects between the legs 88 of the frame 84 and the outer end portion 444 of the cable 70 projects upwardly through the annulus 124 for engagement to a cable pulling device 120. Other and different frame construction configurations can readily be developed which provide the strength and stability of the frame member 84, and such alternative frame members are described hereinbelow.

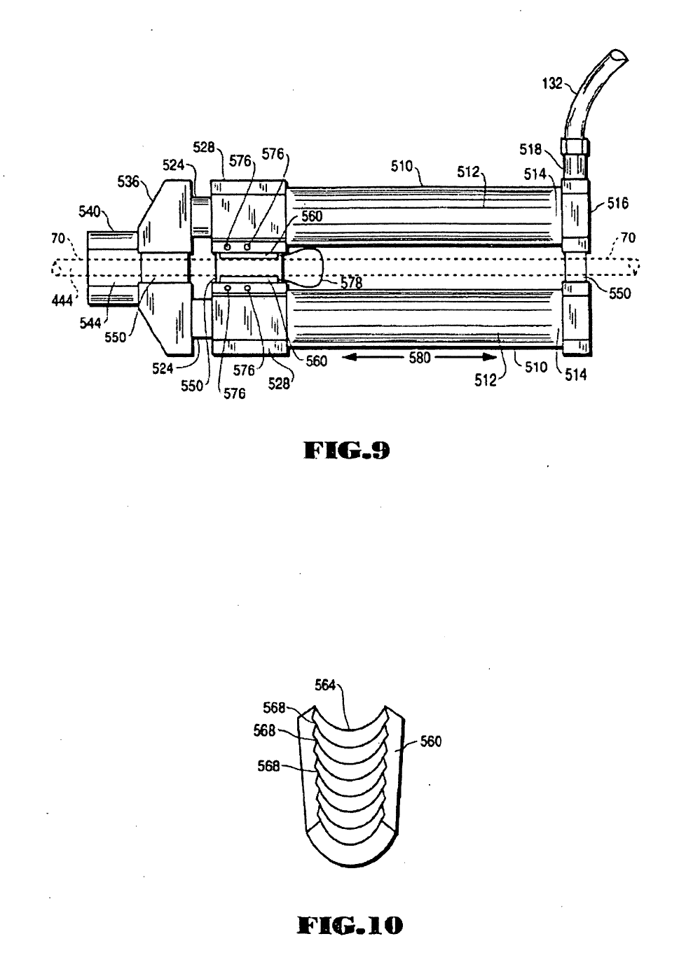

A cable pulling device that is suitable for use in the present invention is depicted in a side elevational view in FIG. 9 and a cable engaging collet of the cable puller is depicted in FIG. 10. The cable puller 120 is preferably formed with two parallelly disposed hydraulic pistons 510 having outer piston housings 512 that are mounted at their rearward ends 514 to a rear end fixture 516. A forward end fixture 528 is engaged to the forward ends of the outer housings 512. The hydraulic lines 132 are engaged to the end fixtures 516 and 528 through a suitable coupling 518 such that hydraulic fluid passes through the hydraulic lines 132, through the end fixtures 516 and 528 and into the two hydraulic pistons 510. Hydraulic push rods 524 project outwardly from the forward end fixture 528 and are fixedly engaged to a front end block 536. A slotted, generally cylindrical nose piece 540 is engaged to the front end block 536. The nose piece 540 is formed with a cable passage slot 544 cut through a side of the nose piece 540, and the outer diameter of the nose piece 540 is sized to mount within the shoulder 434 of the slotted annulus 124 of the frame member 84, as is described hereinbelow with the aid of FIG. 11. A generally U-shaped cable passage slot, generally denoted by the numeral 550 is formed in each of the front end block 536, forward end fixture 528 and the rear end fixture 514, such that the cable 70 can be installed within the cable pulling device 120 from its side. That is, it is not necessary to thread an end of the cable 70 through the cable pulling device 120.

A plurality of cable pulling collets 560 are removably engaged within the cable passage slot 550 of the forward end fixture 528. As depicted in FIG. 10, each collet 560 is formed with a concave inner face 564 having a plurality of cable engaging ridges 568 cut into the inner surface thereof. The cable engaging ridges 568 are cut in a saw-tooth manner to create a one-way cable engagement surface. Collet retaining pins 576 are disposed in the front end fixture 528 to facilitate the replacement of collet members 560 when necessary. The gripping motion of the collets is enhanced by a collet biasing spring 578 that is engaged to the front end fixture and causes the collets to move in a synchronous manner to engage and disengage the cable 70. A preferred cable pulling device 120 utilizes two collets 560 disposed around the cable 70 to effectively engage the cable while permitting the easy side wise installation of the cable 70 within the collets 560. The cable puller 120 may be any of several such pulling devices, as have been built by any of several companies, and have been used for a number of years as post tensioning devices for post tensioning steel cable or rod, such as rebar, in concrete structures, and for tensioning bridge cable, in the bridge building industry. A device that is preferably used as the cable puller 120 is designed as a bridge cable tensioning device, used in the bridge construction industry, such as is manufactured and sold by the Chowder Machine Company of the State of Washington. Such post tensioning devices, also termed Post Tensioning Rams (PTR), have never before been used to pull a length of cable, for pulling or lifting objects; this use has heretofore been assigned to winches, and/or block and tackle, and chain hoists. In the present invention the PTR is used for pulling the mole using varying lengths and size of cable from a few feet, to several thousand feet and the pulling force is not affected by cable length. Such PTR devices are light weight as compared to their pulling capability, generally pulling in excess of ½ ton per pound of weight, such that a 70 pound device 120 can place a 35 ton pulling force on the cable 70. In some embodiments, the PTR in the present invention uses high pressure hydraulics (5,500 to 20,000 PSIG) to give the intense pulling power it delivers, and the PTR's light weight and portability, are the result of using high pressure hydraulics in small hydraulic cylinders. Typical prior art winches, etc., that produce such force levels can themselves weigh 2-5 tons. Thus a significant advantage of the present invention is the use of the light weight bridge cable tensioning device as a cable pulling device 120, which allows a single man to install and operate the present invention in the small hole 32.

It is therefore to be understood that when hydraulic pressure is applied to the two piston members 510, that the outer housing portions 512 of the pistons 510 will move laterally rearwardly 580 relative to the piston rods 524 and the front end block 536. It is also to be realized that when the nose piece 540 of the cable pulling device 120 is mounted in the annulus 124 of the frame 84, that the front end block 536 will remain stationary while the forward end fixture 528 and the two piston outer housings 512 will move rearwardly. Additionally, it is to be understood that the collet members 560 are disposed within the movable forward end fixture 528, and that when the collets 560 move rearwardly relative to the cable 70, that the saw-tooth ridges 568 of the collets 560 will grab the outer surface of the cable 70 and pull it rearwardly. Finally, after the piston housings 512 have traveled rearwardly to the extent of a piston stroke, the housings 512 will return to the forward position and, significantly, the collet ridges 568 will release their hold upon the cable and slide forwardly along the surface of the cable 70. Thus, with each repeatable, rearward cable pulling stroke of perhaps three to six inches, depending upon the piston travel 580 of the cable pulling device 120, the collet ridges 568 will pull the cable 70 rearwardly. Thereafter, upon the return stroke of the cable pulling device 120, the cable 70 will remain stationary while the collets 560 slide along its outer surface. Thus, each cable pulling stroke will pull the cable rearwardly, until, ultimately, the cable with its attached pipe parting mole will be pulled entirely through the pipe 14.

A detailed depiction of the mounting of the cable puller nose piece 540 within the annulus 124 is provided in FIG. 11. As depicted therein, the cable passage slot 430 is formed through the sidewall of the annulus 124 to permit the side wise mounting of a cable 70 into the cable passage bore 428. A shoulder 434 projects inwardly into the cable passage bore 428 to provide a stop on the inward insertion of the cable puller nose piece 540 within the cable passage bore 428, and the outer diameter of the nose piece 540 is sized to slidably fit within the cable passage bore 428 until the front surface 584 of the nose piece 540 rests against the shoulder 434.

As has been described herein, the preferred method for installing the various components of the present invention upon a cable 70 is the side wise insertion of the cable 70 through the mounting slots 430 and 544 of the annulus 124 and nose piece 540 respectively. As depicted in FIG. 11, a preferred orientation of the annulus 124 and nose piece 540, following the insertion of the cable 70 within the cable mounting slots 430 and 544 respectively, is to rotate 588 the cable puller slot 544 through a 90 or more degree angle relative to the annulus slot 430. Thereafter, when the nose piece 540 is inserted within the annulus bore 428, the cable 70 will become locked into the mated structure. That is, if the two slots 544 and 430 are aligned, then the cable 70 can escape through the aligned slots, whereas the rotation 588 of the nose piece 540 relative to the annulus 124 creates a cable enclosing mated configuration. The inventors have found that the preferred, rotated mounting configuration maintains the cable 70 in proper alignment within the cable pulling collets 560, which improves the performance and reliability of the device.

FIGS. 12 and 13 depict an alternative, three-legged cable pulling frame 600 of the present invention, wherein FIG. 12 is a side elevational view and FIG. 13 is an end elevational view. As depicted in FIGS. 12 and 13, the three-legged cable pulling frame 600 includes a first base leg 604, a second base leg 608 and a top leg 612, each of which is preferably formed from rectangular tubular steel stock. The front ends 616 of each of the legs 604, 608 and 612 are engaged, such as by welding to a front mounting plate 620, and a cable passage slot 624 is formed upwardly through the plate 620, such that a cable 70 is mountable therethrough. Further structural members 630 are utilized to engage the rearward ends 634 of the leg members 604, 608 and 612 together, such as by welding, to form a strong structure. A pulley 640 is rotatably mounted upon an axle 644 that is mounted within axle bores 648 formed through a pulley mounting plate 656 that is engaged, such as by welding, to the leg members 604, 608 and 612 and the frame members 630. It is to be realized that such a mounting plate 656 is disposed on each side of the pulley 640 to engage both ends of the axle 644. An annulus mounting plate 670 having a cable passage slot 674 formed therein is engaged, such as by welding, to the upper ends 676 of the frame members 530, and a slotted cylindrical annulus 680 is fixedly engaged, such as by bolting or welding to the annulus mounting plate 670. The annulus 680 is preferably similar in design to the annulus 124 described above. Thus the annulus slot and the mounting plate slot 674 are aligned to permit the sideways mounting of a cable 70 therewithin.

A single reaction plate mounting pin 682 is formed on the plate 620 to facilitate the mounting of the frame 600 with a mating bore (such as mounting pin bores 439) formed in a reaction plate, to which the frame 600 is removably engaged in a manner described herein with regard to frame 84 and reaction plate 96. To further facilitate the engagement of the plate 620 with a reaction plate 96, a generally cylindrical cable guide member 684 is engaged within the slot 624. The guide member is also formed with a slotted cable passage bore 686 to permit the sideways insertion of the cable 70 therewithin. The guide member 684 is preferably formed with a smaller diameter portion 688 for mating insertion within the slot 624 of the plate 620, and a larger, outer diameter portion 690 for mating insertion within the cable mounting slot 104 of a reaction plate 96. In the preferred embodiment, the guide 684 is preferably formed from aluminum to provide a soft guide surface for interaction with the outer surface of the cable 70.

As compared with the four-legged cable pulling frame depicted in FIGS. 6 and 7, the three-legged frame of FIGS. 12 and 13 is generally lighter in weight and shorter in length. These features are generally advantageous because the lighter weight facilitates easier installation and manipulation by a user, and the shorter length facilitates the installation of the frame 600 in a smaller hole 32 than the longer legged frame 84. It is to be realized that the frame 600, like the frame 84, is mountable upon a pre-installed cable 70, such that the extending end of the cable 70 may be inserted within the cable mounting slots 684 and 624, wrapped around the pulley 640 and installed within the cable mounting slot 674 of the plate 670 and within the slotted annulus 680.

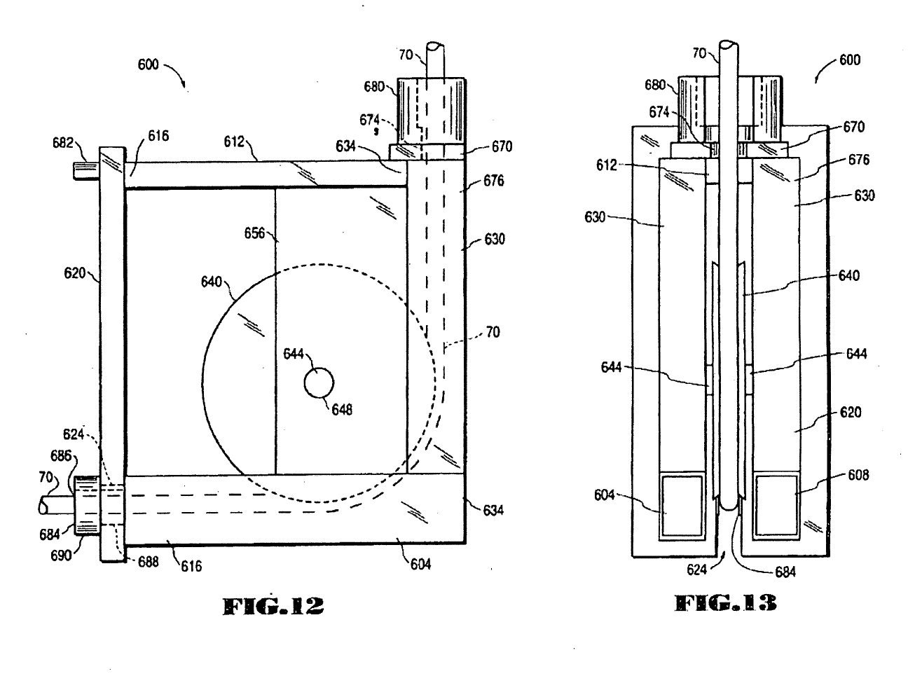

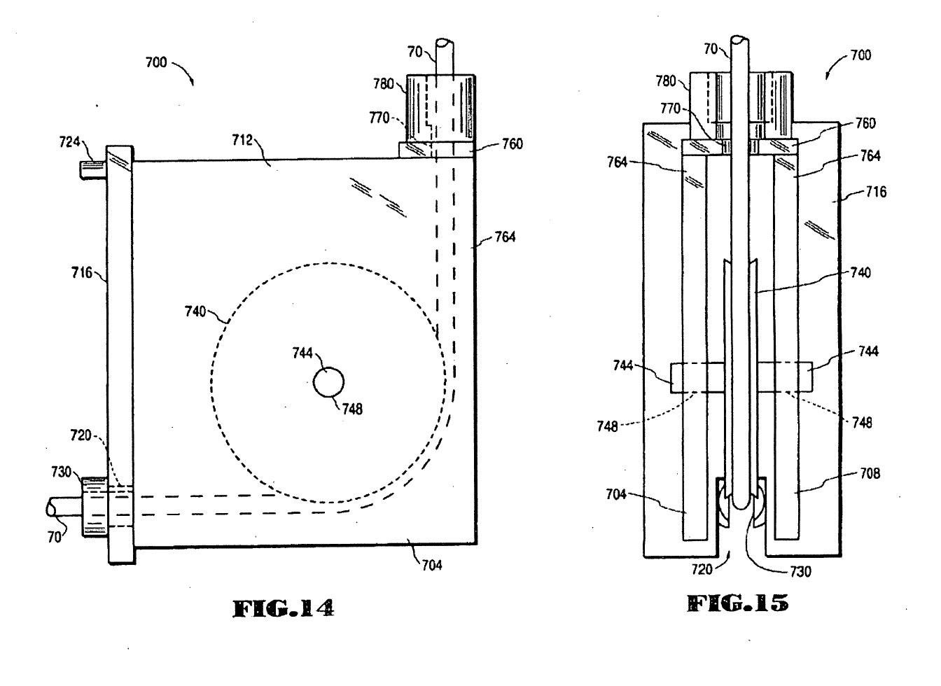

Still another cable pulling frame 700 of the present invention is depicted in FIGS. 14 and 15, therein FIG. 14 is a side elevational view and FIG. 15 is an end elevational view. As depicted in FIGS. 14 and 15, the frame 700 includes a left plate member 704 and a right plate member 708 that are fixedly engaged at a forward edge 712 to a front plate 716. The engagement may be by welding, threaded bolts or other conventional means. The front plate 716 is formed with an upwardly projecting cable insertion slot 720 and a reaction plate mounting pin 724, which is similar to mounting pin 682 of frame 600 and which mounts into a mating bore (such as bores 439) formed in a reaction plate. As with frame 600, a slotted guide member 730 may be engaged within the slot 720, which guide member 730 has an enlarged outer diameter portion 732 to slidably fit within a cable slot 104 formed in a reaction plate 96. A cable pulley 740 is rotatably mounted upon an axle 744 that projects through axle mounting holes 748 formed through the side plates 704 and 708. An annulus mounting plate 760 is fixedly engaged, such as by welding or threaded bolts to the top portions 764 of the side plates 704 and 708, and a cable mounting slot 770 is cut into the plate 760 for insertion of the cable 70 therethrough. A slotted annulus 780, similar in design to annulus 124, is mounted upon the plate 760, such as by welding or the utilization of threaded bolts, to provide for the mounting of a nose piece 540 of a cable pulling device 120 therewithin.

Frame 700 is generally easier to fabricate than frame 600, although its overall dimensions are quite similar. Frame 700 generally consists of fewer components than frame 600 and is easier to assemble, whether by welding or the use of threaded bolts. It is to be understood that the frame 700, like frame 600 and frame 84, may be mounted upon a projecting end of an in-place cable 70, such that the cable 70 is mounted sideways into the cable insertion slots and wrapped around the pulley 740, as has been described in detail hereabove.

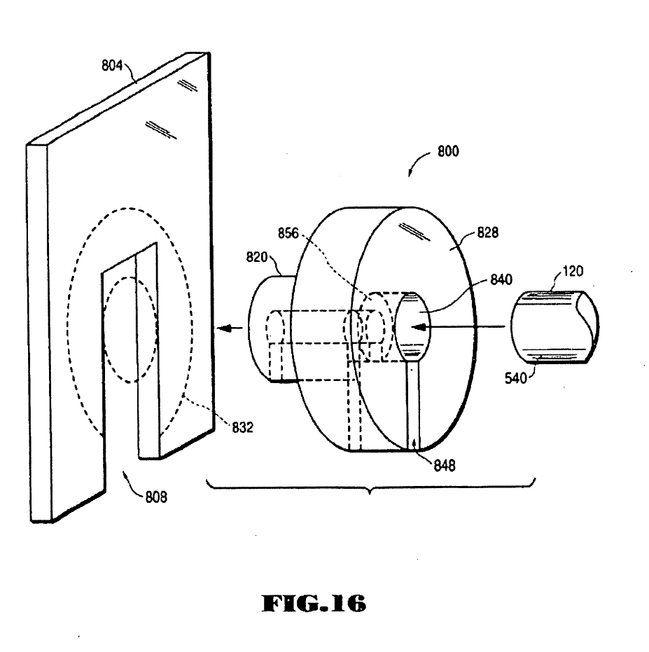

A further embodiment of the present invention is depicted in FIGS. 16, 17 and 18, in which FIG. 16 is an exploded perspective view, FIG. 17 is an end elevational view of an adapted annulus member 800 and FIG. 18 is a side elevational view of the annulus member 800 depicted in FIG. 17. As depicted in FIG. 16, a generally rectangular reaction plate 804 is formed with a cable insertion slot 808 therewithin. Generally cylindrical annulus member 800 is formed with an inner, generally cylindrical nose portion 820, having an outer diameter that is sized for insertion within the width of the slot 808. The annulus member 800 further includes an enlarged body portion 828 having a diameter that is significantly larger than the diameter of the nose portion 820, such that the enlarged portion 828 provides a large contact area 832 (shown in phantom upon the surface of the reaction plate 804) when the nose 820 of the annulus member 800 is inserted within the slot 808 of the reaction plate 804. A cable passage bore 840 is formed axially through the annulus member 800 and a cable mounting slot 848 is cut through the side of the member 800, such that the cable 70 may be sideways inserted into the cable bore 840. As with the annulus member 124, described herein, the center bore 840 is formed with a diameter sized for the insertion of the nose piece 540 of a cable pulling device 120, and an inwardly projecting shoulder 856 is formed within the bore 840 to form a stop on the inward insertion of the nose piece 540 within the bore 840. It is therefore to be understood that the embodiment depicted in FIGS. 16, 17 and 18 facilitates the direct usage of the cable pulling device 120 in a horizontal orientation within an access hole 32, or within a pre-existing space, such as a large sewer main or a building basement, where it is not necessary to reorient the cable vertically out of a hole, such as hole 32 depicted in FIG. 1.

In some working environments, a backward pulling force such as cable stretch or plastic pipe stretch may exist upon the cable 70 such that the cable may be pulled backwardly into the pipe 14 between the pulling strokes of the cable pulling device 120. In such a situation, a retaining collet may be inserted within the bore 428 of the annulus 124. Such a retaining collet includes two or more collet members such as collet members 560, held within a slotted cylindrical member, and which collets have reverse sawtooth ridges that grip the cable upon its movement backwards within the annulus.

Upon consideration of the various preferred embodiments described in detail herein, it is to be understood that a generalized description of the present invention includes a mole, a cable attachable to the mole for pulling it through a pipe, a cable pulling device that is engagable to the cable and a cable pulling device engagement means which functions to provide a reactive support for the cable pulling device. In various embodiments, the cable pulling device engagement means includes the reaction plate and an annulus type member for holding the cable pulling device and may further include the various mounting frames and their components depicted and described herein. Significant features of the mole of the present invention include a plurality of pipe scoring wheels wherein two such wheels may be located on one side of the mole for enhanced pipe scoring, and wherein pipe scoring wheels can be located at 180.degree. opposite surfaces of the mole for enhanced pipe scoring and parting of the pipe along the opposing scored lines. The preferred cable pulling device of the present invention is a hydraulic bridge cable tensioning device that operates in a cyclic cable pulling manner, having repeatable short pulling strokes. The cable is sideways mountable within the cable pulling device for ease of mounting and assembly. The cable pulling frames components and annulus are formed with cable mounting slots, such that these components may also be sideways mounted upon the cable for ease of assembly of the device.

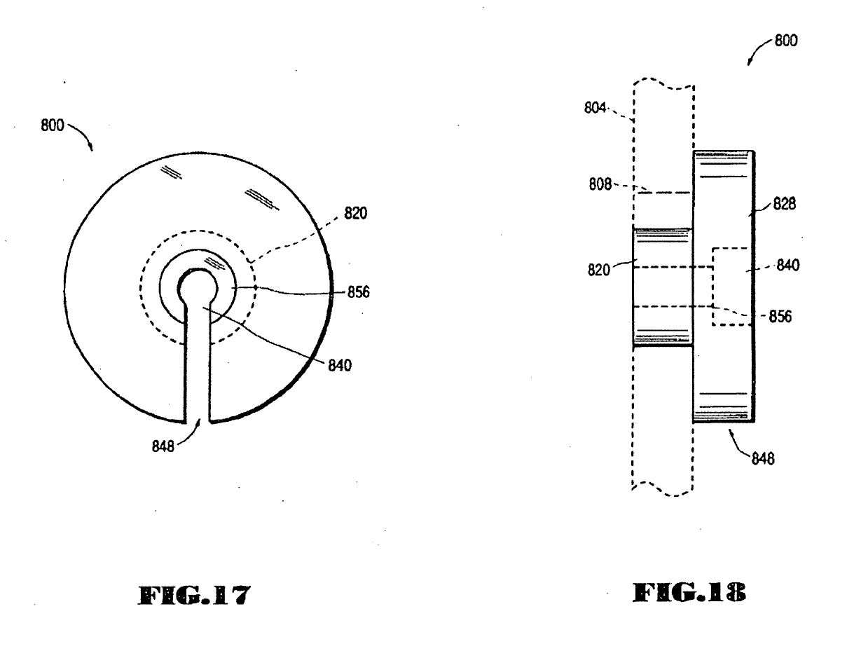

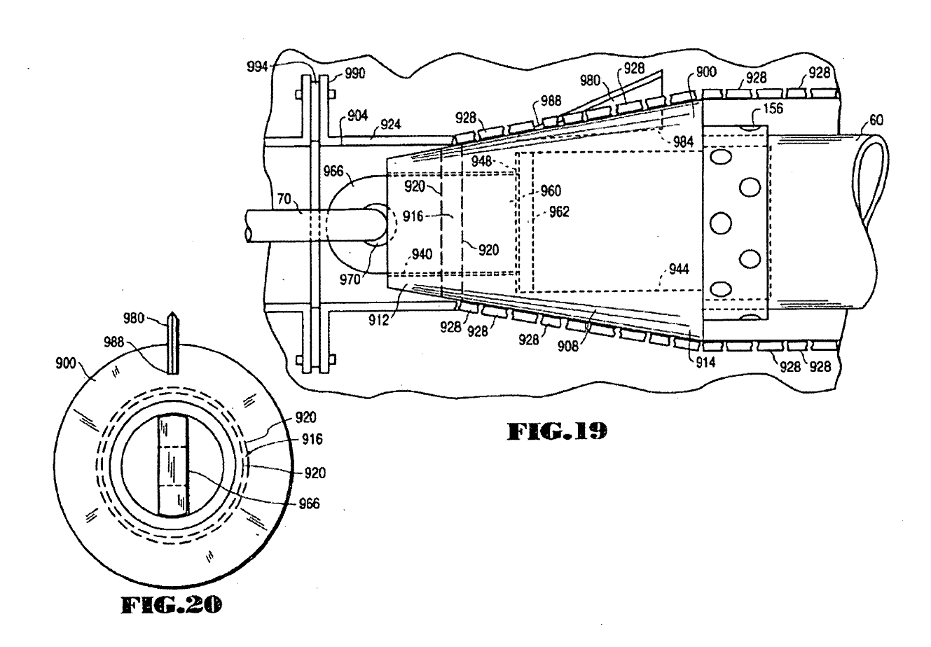

A further mole design 900 is depicted in FIGS. 19, 20 and 21, wherein FIG. 19 is a side elevational view of the mole 900 depicted in a pipe bursting operation; FIG. 20 is a front elevational view of the mole 900 and FIG. 21 is a side elevational view of the mole 900 depicted in a further stage of a pipe bursting operation. As depicted in FIG. 19, the mole 900 is being pulled through a pipe 904 composed of fracturable material, such as cast iron or ceramic pipe. A pulling cable 70 is engaged to the mole 900 as has generally been described herein. The mole 900 includes a tapered body portion 908 having a front end 912 whose diameter is less than the diameter of the pipe 904 and a rearward end 914 whose diameter is greater than the diameter of the pipe 904. The tapered body 908 of the mole engages the pipe at a pipe engagement region 916 generally existing between the dotted pipe engagement lines 920, such that a forward, intact section of pipe 924 exists in front of the engagement lines 920 and fractured pipe segments 928 exist behind the pipe engagement lines 920. It is therefore to be understood that a generalized outward force that is uniformly, circumferentially applied to the pipe 904 in the engagement region 916 causes the pipe material to fracture due to the large pulling force applied to the mole 900 through the cable 70. Therefore, in the mole embodiment 900 a smooth tapered surface mole is utilized to burst the fracturable pipe 904.

As depicted in FIG. 19, a cylindrical bore is formed axially through the mole 900. The bore includes a forward portion 940 having a first diameter and a rearward portion 944 having a larger diameter, such that a shoulder 948 is formed in the inner surface of the central bore. A cable engaging member 960 having a round base portion 962 and a forwardly projecting cable engagement tongue 966 is insertable into the mole 900 from the rearward end of the bore 944. The diameter of the round portion 962 is sufficiently large to engage the shoulder 948 and a cable engagement hole 970 is formed in the outer portion of the tongue 966 such that the cable may be engaged thereto. As has been discussed herein, replacement pipe 60 is engaged to the rearward end of the mole 900, such as through the use of a retaining sleeve 156 as described herein.

A single blade 980 may be engaged within a blade holding slot 984 to project from the side of the tapered body portion 908. Significantly, the frontward edge 988 of the blade 980 is disposed rearwardly of the pipe fracturing region 916, such that the blade 980 is not utilized in the pipe fracturing activity of the mole 900. The blade 980 is utilized where the mole 900 encounters pipe engagement fixtures such as the pipe flanges 990 which include a flexible seal 994. Specifically, as depicted in FIG. 21 and in comparison to FIG. 19, the mole 900 has been pulled (leftward) through the pipe 904 past the flange members 990, such that the pipe around the flange members has been fractured. Nevertheless, the flexible seal member 994 has remained intact. In testing with smooth tapered surface moles, the inventors have found that such moles work very well in fracturing pipe, however seals such as 994 sometimes create significant drag. Blade 980 thus augments the mole 900 by providing a sharp edge which will cut through the seal 994, whereby it will pass around the mole and not create a drag problem. It is therefore the case that a smooth tapered mole, without any fins is quite adequate to fracture and replace fracturable pipe such as cast iron and ceramic. Where certain types of pipe joinder fixtures are encountered, a blade 980 may be required to efficiently remove portions of the pipe engagement fixture from around the mole.

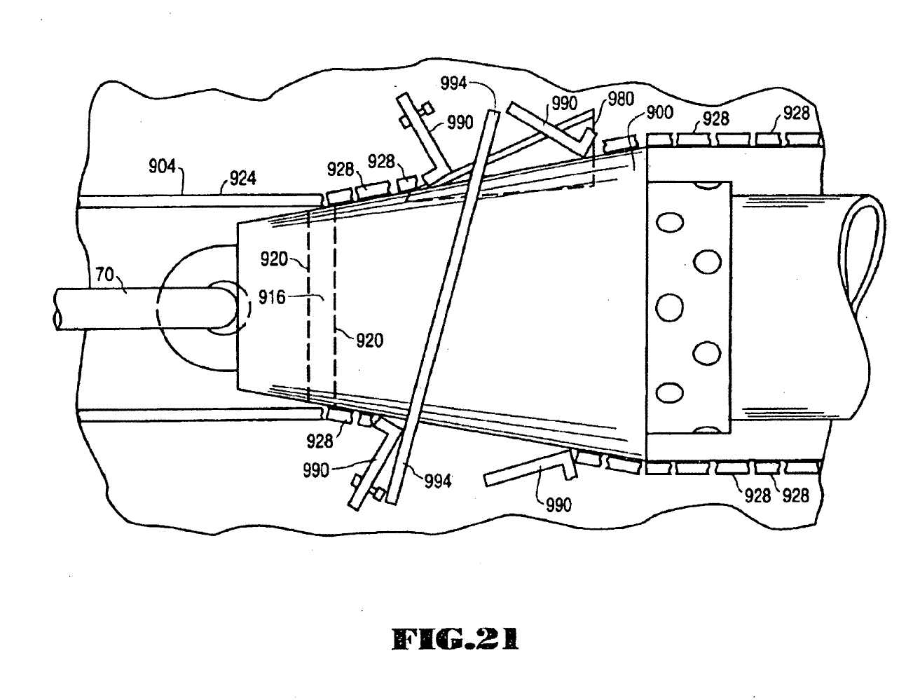

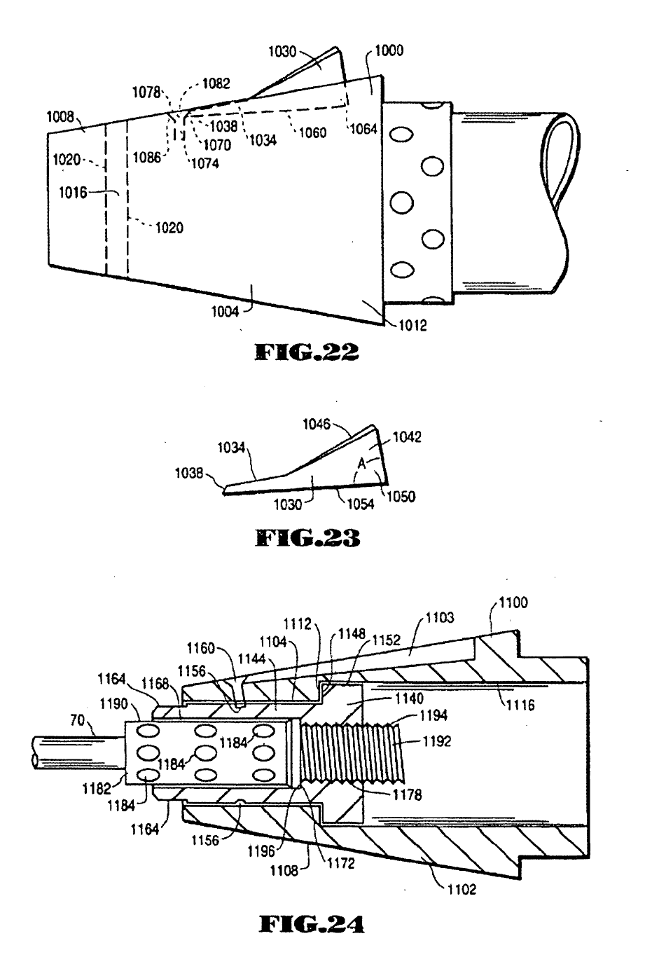

Still further alternative mole designs are depicted in FIGS. 22 and 23, wherein FIG. 22 is a side elevational view depicting an alternative fin design with a mole, and FIG. 23 is a side elevational view of the fin depicted in FIG. 22. As depicted in FIG. 22, a mole 1000 is formed with a tapered body portion 1004 having a front end 1008 whose diameter is less than the diameter of a pipe (not shown) through which the mole will be pulled, and a rearward end 1012 having a diameter that is larger than the diameter of the pipe. The mole 1000 is therefore substantially similar to the mole 900 depicted in FIGS. 19, 20 and 21. Specifically, a pipe engagement region 1016 is generally defined as lying between two dotted pipe engagement lines 1020. The significant, novel features of the mole 1000 are found in the shape of a flange seal splitting fin and the method of engagement of the fin to the mole body 1004.

As can be seen with the help of FIG. 23, the fin 1030 is formed with a relatively narrow frontward portion 1034 that has a beveled frontward tip 1038. The rearward portion 1042 of the fin projects outwardly and includes a cutting edge 1046 to engage and cut flange seals, as described herein with regard to mole 900 and depicted in FIG. 21. The rearward edge 1050 of the fin projects downwardly to form an angle A of approximately 80.degree. with the base 1054 of the fin.

Returning to FIG. 22, the fin 1030 resides in a fin engagement slot 1060 formed in the surface of the mole body 1004 such that the narrow frontward portion 1034 of the fin resides completely within the slot 1060. The rearward portion 1064 of the slot 1060 is formed with a corresponding approximately 80.degree. angle, such that the rearward portion of the fin (defined by angle A) is matingly engaged therein. The frontward end 1070 of the slot 1060 includes a threaded bore 1074 for receiving a threaded screw 1078 having a tapered head 1082. The frontward edge 1086 of the slot 1060 is tapered to receive the head 1082 of the screw 1078 therewithin, and the tapered frontward tip 1038 of the fin 1030 is matingly engaged by the head 1082 of the screw 1078. It is therefore to be understood that the fin 1030 resides in the slot 1060 such that the frontward tip 1038 is held in place by the head 1082 of the screw 1078 and the rearward edge 1050 of the fin 1030 is held in place by the rearward end 1064 of the slot 1060 that has an angle A of approximately 80.degree. It will therefore be appreciated by those skilled in the art that the fin 1030 can easily be removed entirely for general pipe fracturing operations, and that the fin 1030 can be easily inserted should the need arise.

FIG. 24 depicts and alternative method for the engagement of a pulling cable 70 with a mole 1100. As depicted therein, the mole 1100 is formed with a smooth tapered pipe engagement surface 1102 having a blade slot 1103 formed therein. A smooth cylindrical bore 1104 is formed axially into the nose portion 1108 of the mole 1100, and an outwardly projecting shoulder 1112 connects the bore 1104 with a larger interior bore 1116.

A generally cylindrical mole engagement nut 1140 resides within the bores 1104 and 1116 of the mole. The nut 1140 includes a cylindrical outer portion 1144 that resides within bore 1104, an outwardly projecting shoulder 1148 that matingly engages shoulder 1112 of the mole, and an enlarged cylindrical portion 1152 that resides within the mole bore 1116. It is therefore to be understood that the nut 1140 is insertable into the mole through bore 1116 until the nut shoulder 1148 engages the mole shoulder 1112. A circumferential groove 1156 is formed in the outer surface of the cylindrical portion 1144 and a threaded screw 1160 is insertable in a threaded bore formed in the mole surface 1102 to hold the nut 1140 within the mole during the cable attachment process. The nut further includes a projecting hex nut end portion 1164 that is formed with flat hex nut surfaces, such that a wrench can be applied thereto to rotate the engagement nut 1140. The engagement nut 1140 further includes a cylindrical bore 1168 that is formed axially into the nut 1104. The bore 1168 terminates at an inwardly projecting shoulder 1172 which joins an inner threaded bore 1178.

A cable end fixture 1182 is engaged to the end of the pulling cable 70 by impact swaging 1184 an outer sleeve 1190 of the fixture 1182 onto the cable 70. The end 1192 of the fixture 1182 is formed with threads 1194 that threadably engage the threaded bore 1178 of the mole engagement nut 1140. The fixture 1182 is further formed with a radially projecting shoulder 1196 that engages the bore shoulder 1172 when the fixture 1182 is fully threadably engaged with the nut 1140.

It is therefore to be understood that the nut 1140 is first inserted into the mole bore 1116 and the screw 1160 is tightened such that it projects into the groove 1156 to hold the nut within the mole 1100. Significantly, the nut 1140 is rotatable within the mole bore 1116. Thereafter, the threaded cable end fixture 1182 is inserted into the bore 1168 and a wrench is then operatively engaged with the hex nut end portion 1164 of the nut 1140. The engagement nut 1140 is thereby rotated until the fixture 1182 is fully threadably engaged with the nut 1140. Thereafter, the pulling force upon the cable 70 will pull the nut 1140 and the engagement of the shoulders 1148 and 1112 will cause the mole to be pulled with the cable. The mole and cable are rotatable with respect to each other.

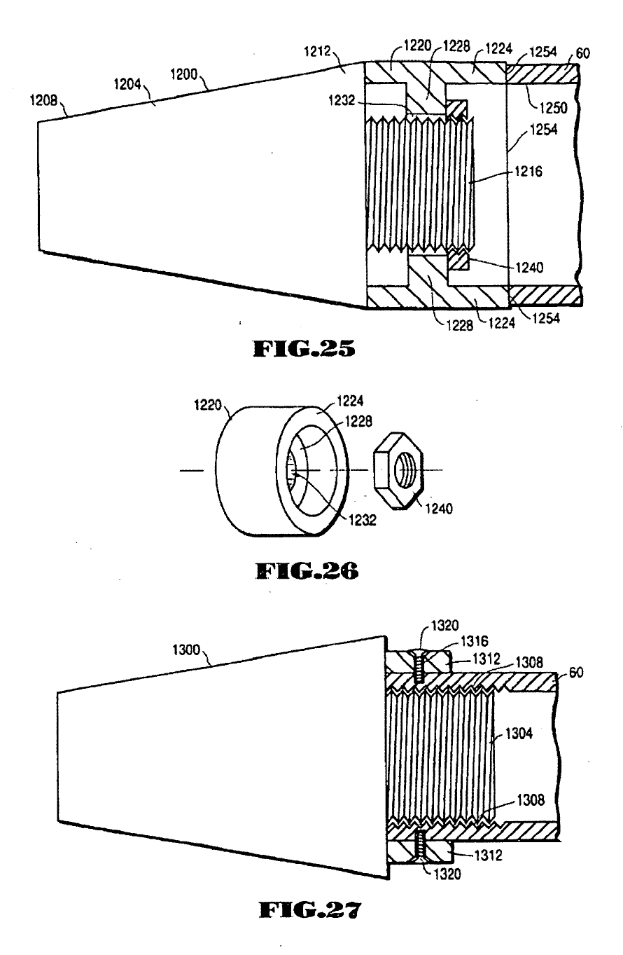

An alternative method for the attachment of replacement pipe to the rearward end of a mole is depicted in FIGS. 25 and 26, wherein FIG. 25 is a side elevational view of the replacement pipe attachment and FIG. 26 is a perspective view of the replacement pipe attachment sleeve. As depicted in FIGS. 25 and 26 a mole 1200 has a tapered smooth body 1204 having a relatively narrow frontward end 1208 and a relatively wide rearward end 1212. A threaded, cylindrical sleeve engagement member 1216 is integrally formed with the mole body 1204 and projects rearwardly therefrom. As indicated hereabove, such a simple mole performs quite adequately for fracturable pipe such as cast iron and ceramic materials. In fact, such a smooth mole will even split steel pipe due to the large pulling forces applied to it.

A replacement pipe engagement sleeve 1220 comprises a generally cylindrical member having cylindrical sidewalls 1224 that are at least as thick as the sidewalls of the replacement pipe 60. The sleeve 1220 further includes a radially, inwardly projecting wall portion 1228 having a bore 1232 formed therethrough, such that the threaded sleeve engagement member 1216 projects through the bore 1232 when the sleeve 1220 is mounted to the rearward end 1212 of the mole 1200. A large threaded nut 1240 is threadably engaged upon the threads of the sleeve engagement member 1216 to frictionally engage the inwardly projecting wall 1228, such that the threadable tightening of the nut 1240 will cause the sleeve 1220 to be engaged to the mole 1200. The end 1250 of the replacement pipe 60 is thermofusion bonded 1254 to the wall 1224 of the sleeve 1220 after the nut 1240 has been threadably tightened to engage the sleeve to the mole. It is therefore to be understood that the replacement pipe 60 is engaged to the sleeve 1200 utilizing a thermofusion bond 1254 and the sleeve 1200 is threadably engaged to the mole 1200.

FIG. 27 is a side elevational view depicting still another method for the engagement of the replacement pipe to a mole. As depicted therein a mole 1300, which is similar to mole 1100 and 1200, is formed with a rearwardly projecting threaded pipe engagement member 1304. The replacement pipe 60 is formed with internal threads 1308 that threadably engage the threads on the member 1304, whereby the replacement pipe 60 is engaged to the mole 1300. A cylindrical sleeve 1312, preferably formed of steel or a similar hard metal is disposed externally of the threads 1308 at the end of the replacement pipe 60 to prevent the pipe 60 from separating from the mole 1300. A plurality of threaded screw holes 1316 are formed through the sleeve 1312 and threaded bolts 1320 are inserted therewithin to further hold the sleeve 1312 and pipe 60 together in engagement with the threaded sleeve engagement member 1304.

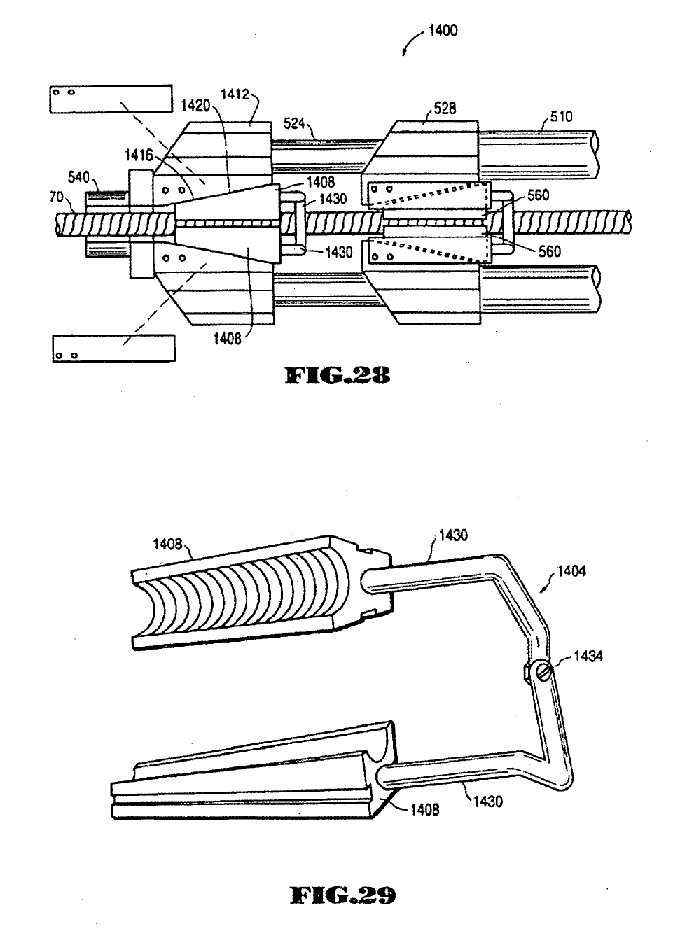

An improved PTR cable pulling device 1400 is depicted in FIG. 28 and cable pulling collets 1404 for the device 1400 are depicted in FIG. 29. Comparing the cable pulling device 120 depicted in FIG. 9 with the cable pulling device 1400 depicted in FIG. 28, it will be seen that the significant difference between the two cable pulling devices 120 and 1400 is that a second pair of collets 1408 is disposed in the front end block 1412 of the cable pulling device 1400 as compared to the front end block 536 of the PTR cable pulling device 120. To accommodate the collets 1408, the front end block 1412 is larger than the front end block 536 of cable puller 120.

As was previously described with regard to cable puller 120, and with reference to FIG. 28, when the hydraulic pistons 510 are activated the forward end fixture 528 moves away from the front end block 1412. The rearward motion of the forward end fixture 528 causes the collets 560 to close upon and grab the cable 70, pulling it rearwardly (to the right in FIG. 28). Significantly, the front collets 1408 do not grab the cable 70 during the rearward motion caused by the movement of the fixture 528. After the fixture 528 has completed its stroke of generally two to six inches, the forward end fixture 528 returns to its starting position and, the collets 560 release their hold upon the cable and slide forwardly along the surface of the cable. As has been indicated hereabove, where significant resistive force exists in the cable, the cable may stretch, whereupon the cable will not remain stationary, but rather it returns to its unstretched condition. It has been experienced that a long cable may actually stretch one to three inches, thereby significantly reducing the cable motion gain of each stroke of the cable puller.

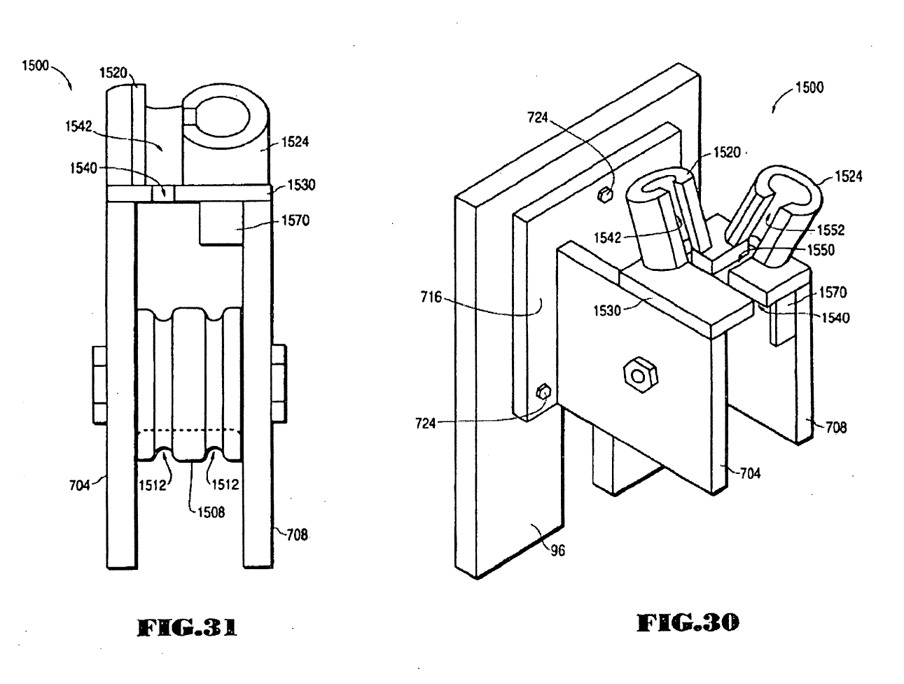

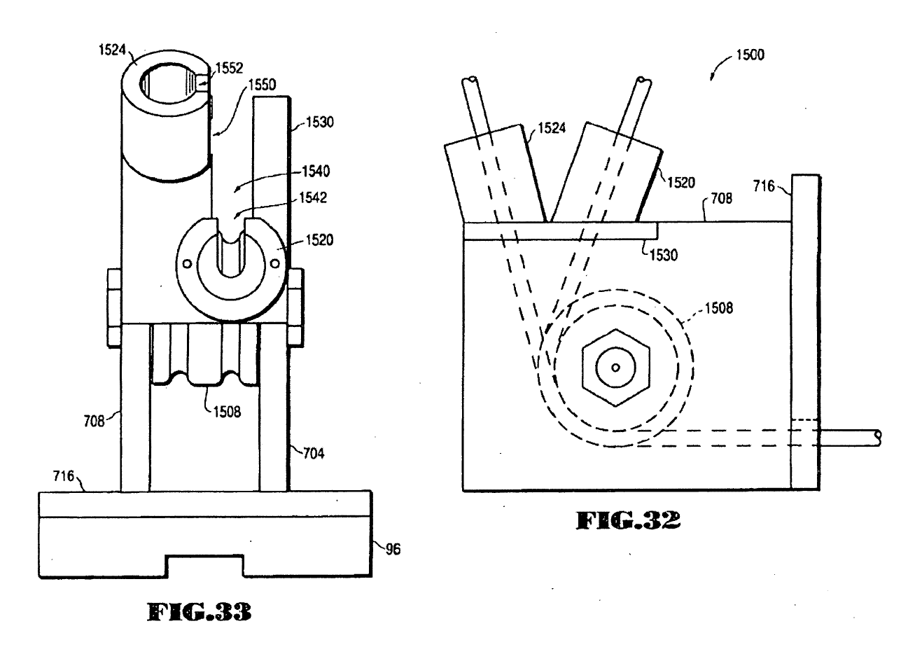

The front collets 1408 are thus provided to prevent the cable from returning to its unstretched position. Specifically, after a cable pulling stroke, and assuming that there is some cable stretching within the cable, upon release of the rearward collets 560, the cable will tend to move towards its unstretched position which would be leftward in FIG. 28. At this point the forward collets 1408 engage the cable and, due to the tapered surfaces 1416 of the collets 1408 and the collet engagement surfaces 1420 of the block 1412, the collets 1408 engage the cable and prevent its leftward motion, thereby retaining the tension in the cable. The frontward collets 1408 thereby prevent leftward cable motion and increase the efficiency of the cable pulling device by insuring that each cable pulling stroke will pull the cable a full stroke length, without significant cable return motion upon cable release by the pulling collets 560. While various collet designs are suitable, as depicted in FIG. 29, the preferred collet design includes two cable engagement members 1408 that are rotatable about a collet engagement rod 1430, and which are pivotable about a rod engagement screw 1434. It is therefore to be understood that the improved PTR cable pulling device 1400 provides for cyclic pulling of the cable 70 while it prevents any cable return motion between pulling strokes due to the use of the forward cable engaging collets 1408.

Where large pulling forces are required it may be necessary to attach two cables to a single mole and utilize two cable pulling devices, such that each cable pulling device is operating on one of the two cables. To effectively accomplish this, a pulling frame that accommodates two cables and two pulling devices is required. Such a pulling frame is depicted in FIGS. 30, 31, 32 and 33, wherein FIG. 30 is a perspective view, FIG. 31 is an end elevational view, FIG. 32 is a side elevational view and FIG. 33 is a top plan view. As depicted in FIGS. 30-33, the dual cable frame 1500 is similar in many respects to the cable pulling frame 700 depicted in FIGS. 14 and 15. Specifically, the frame 1500 is mountable upon a reaction plate 96. It includes a left plate member 704 and a right plate member 708 that are engaged to a front plate member 716 that is mountable to the reaction plate 96 utilizing mounting pins 724. A pulley 1508 having two cable grooves 1512 is mounted between the left and right plate members. Two slotted annuluses 1520 and 1524 are mounted upon a mounting plate 1530. Mounting plate 1530 is formed with a cable passage slot 1540 that is aligned with the cable passage slot 1542 formed in the annulus 1520, such that a cable can be sideways mounted therethrough. Similarly, mounting plate 1530 is formed with a cable mounting slot 1550, which intersects slot 1540 and which is aligned with the cable mounting slot 1552 of the annulus 1524, such that a cable can be sideways mounted therewithin. Due to the existence of mounting slot 1540, the mounting plate 1530 is not structurally well supported on both sides. Therefore, an additional structural support member 1570 is engaged to plate member 708 beneath the mounting plate 1530 to provide additional structural support to the mounting plate. As is best seen in FIGS. 30 and 32, the two annulus members 1520 and 1524 are mounted at an angle with respect to each other. This angular mounting is necessary in order to provide operational space for the two cable pulling members that will be mounted into the annulus members 1520 and 1524. In order to accomplish the angled mounting, the base portions of the two annulus members are cut at an angle to the central axis thereof. It is therefore to be understood that the dual cable mounting frame 1500 provides for the simultaneous mounting and usage of two cable pulling devices, each pulling a separate cable that is mounted to a single mole. The dual cable pulling frame thereby permits the user to apply the pulling force of two cable pulling devices to a single mole to pull it through even the most difficult pipe environments.

The significant advantages of the present invention are its relatively small, light weight components which allow a single operator to transport, install and operate the device for trenchless replacement of underground pipe. The larger pulling force generated by the PTR cable pulling device allows it to pull the mole through pipe of varying diameters and composed of virtually any pipe material, whether it be fracturable (such as cast iron or ceramic) or malleable (such as steel). The relatively low cost of the components permit individual contractors and small companies to effectively compete in a marketplace that heretofore has been reserved for large companies having the manpower and resources to purchase and transport the relatively large and expensive components that heretofore have been necessary to conduct the trenchless replacement of underground pipe.

### Additional Embodiments

### Low Pressure Puller

Another embodiment of the present invention uses lower pressure hydraulics such as that found in typical tractors, backhoes and loaders, typically under 5,500 PSIG and capable of flow rates of over 100 gallons per minute, with appropriate hydraulic cylinders that give the intense pulling power needed. The embodiments described herein provide a system, device and method for trenchless replacement of underground pipe comprising elements described herein and enabling operation with any, even low pressure hydraulic system. Such hydraulic systems are found in a wide variety of machinery and equipment today including but not limited to back hoes, front loaders, tractors, garbage trucks, fork lifts, lawn mowers, log splitters and pressure washers. The embodiments disclosed enable the devices, systems and methods with low hydraulic pressures, even as low as, for example, 1000 PSI. While embodiments herein will be generally described in terms of hydraulic oil, these low pressure systems can by run with cylinders adapted to any hydraulic system including compressed water (e.g. by using stainless steel pistons and polyethylene seals), or, for example, compressed air.

For example, a puller with two identical hydraulic cylinders, with 3.75″ diameters, gives a hydraulic multiplier of about 22 (the formula for the multiplier that converts PSI of hydraulic pressure to linear force in pounds being simply the area of the active face of the cylinder, in square inches, and hence 2*pi*r̂2=2*3.14*(3.75/2)̂2˜22.08 pounds-force/PSI). In this way, a hydraulic system that provides 2000 PSI will produce about 22 tons of pull. With a hydraulic flow rate of, say, 24 gpm, such a system is capable of pulling at a speed of about 21 feet per minute, since the formula for the number of inches of pull per minute is:

# gpm.*231 cu. in./gal.*1/area sq. in.

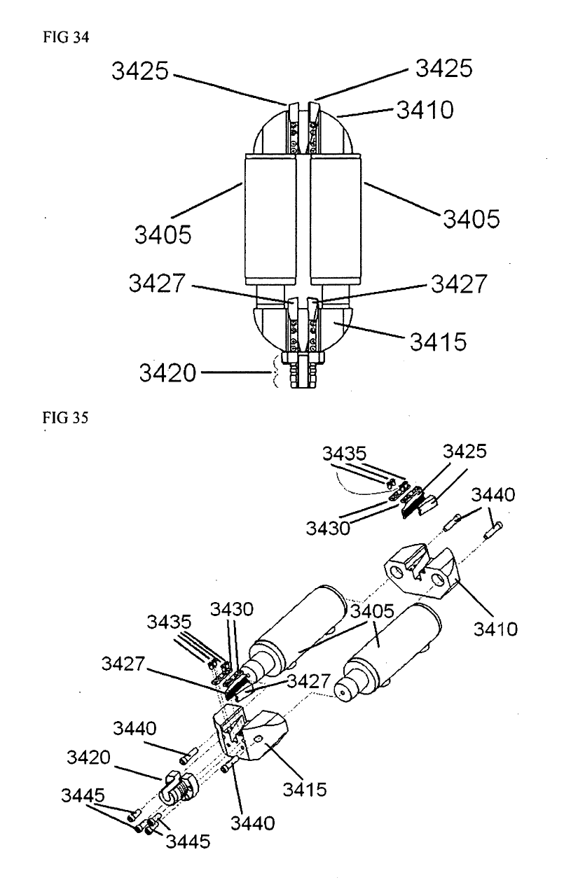

That is 24 gal./min.*231 cu. in./gal.*1/22.08 sq. in., which is about 250 in. per min. This yields an effective pull rate of about 10 feet per minute since there is a pulling stroke and a recovery stroke. Note that a tractor or backhoe hydraulic system is often capable of much higher flow rates, but in the present embodiment a limiter can be used to set the flow rate at, say, 24 gpm. This number is meant to be illustrative and not limiting, and other flow rates are possible. Similarly, the numbers for pressure are also illustrations and other values are possible. A puller in accordance with the present embodiment of the invention still has the benefits of light weight and portability, since the cylinders are relatively small due to the efficient design of an embodiment such as the one illustrated in FIG. 34. Typical prior art winches, etc., that produce such force levels can themselves weigh 2-5 tons. Thus a significant advantage of the present invention again, is the use of the light weight cable tensioning device as a cable pulling device 120, which allows a single man to install and operate the present invention in a small hole 32.

In more detail, FIG. 34 shows, in front elevational view, an embodiment of a low pressure puller in accordance with the present invention. FIG. 35 shows a three dimensional view indicating the assembly of the embodiment depicted in FIG. 34. The low pressure puller shown in FIG. 34 and FIG. 35 is an embodiment of a cable pulling device 120 in accordance with the present invention. Note that in discussions of the present embodiment, the direction “up”, or “top” will refer to the top of FIG. 34. In discussions of certain other embodiments herein, this direction corresponds to the rearward direction. Similarly “bottom” or “lower” will refer to the bottom or lower part(s) within FIG. 34.

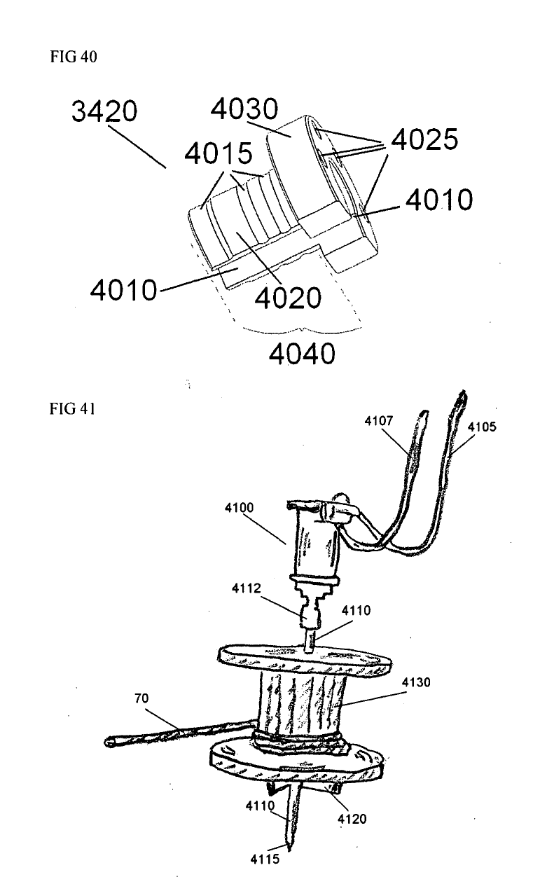

The cable pulling device 120 shown in FIGS. 34 and 35 comprises one or more hydraulic cylinders 3405, (two are shown in the embodiment depicted), gripping elements 3425 and 3427, a top fixture 3410 to which the top of the cylinder(s) is/are fixedly attached, and a bottom fixture 3415 to which the bottom of the cylinder(s) is/are fixedly attached, and to which a nose piece 3420 is fixedly attached. As seen in FIG. 40, the nose piece 3420 is formed with a cable passage slot 4010 cut through a side of the nose piece 3420, and the outer diameter of the nose piece 3420 is sized to mount within the shoulder 434 of the slotted annulus 124 of the frame member 84, as is described herein with the aid of FIG. 11.

A cable passage slot is therefore formed within each portion of the system that meets with the cable, in that the cable 70 can be installed within the cable pulling device 120, from the side of the cable 70, between the pair of grippers 3425, between the pair of grippers 3427, and in the slot 4010 of the nose piece 3420 (see FIG. 40 for the latter). In this way, the cable 70 can be installed within the cable pulling device 120 from its side, and it is not necessary to thread an end of the cable 70 through the cable pulling device 120.

The hydraulic cylinders 3405 typically have two ports for hydraulic fluid, and are capable of extending or retracting a piston depending on which of these two ports receives higher pressure hydraulic fluid. In this way, the cylinders create two cycles within the present system to create a pulling stroke and a recovery stroke. In the embodiment depicted in FIG. 34, the pulling stroke corresponds to the hydraulic extension of the pistons, and the recovery stroke corresponds to the hydraulic retraction of the pistons.

In the embodiment, the gripping elements switch between gripping and releasing, as the hydraulic system switches between the two strokes. Grippers in accordance with the embodiment can, for example, be like those shown in FIG. 29. As shown in FIG. 34, when the hydraulic cylinders 3405 extend, this causes an upward pressure on the top grippers 3425. The inner surface of the top grippers 3425, by friction against the cable 70, will resist this force to some degree and thus be forced downward into the wedge shaped channel 3710 within the top fixture 3410 (see FIG. 37). This causes the grippers 3425 to come together and grab the cable 70. In this way the grippers 3425 grip the cable 70 during the pulling stroke, and the cable 70 is pulled up by that stroke. When the puller 120 gets to the end of the pulling stroke and goes into the recovery stroke, a downward force is then exerted on the upper fixture 3410. This, combined with the friction between the grippers 3425 and the cable 70, cause the grippers 3425 to move upward relative to the upper fixture 3410, and so the upper set of grippers 3425 release the cable 70 during the recovery stroke. In a similar way, the lower grippers 3427 will grab the cable during the recovery stroke, and release it during the pulling stroke. Note that in the forgoing description, the grippers, e.g. 3425, are comprised of a pair of gripping wedges that can move within a wedge shaped channel 3710. In some embodiments, more than two wedges can be used. In some embodiments, at least one of these wedges is fixedly attached to the fixed element 3410, and does not move. The gripping still results from the movement of the remaining wedge shaped pieces.

One of skill in the art will recognize that other gripping mechanisms are possible. The present invention is intended to include but not be limited to these other mechanisms, such as mechanisms whereby gripping elements switch between gripping and releasing via a predetermined mechanical control comprising a control system in which the mechanical action and forces of one or more hydraulic elements cause the grippers to grip and release.

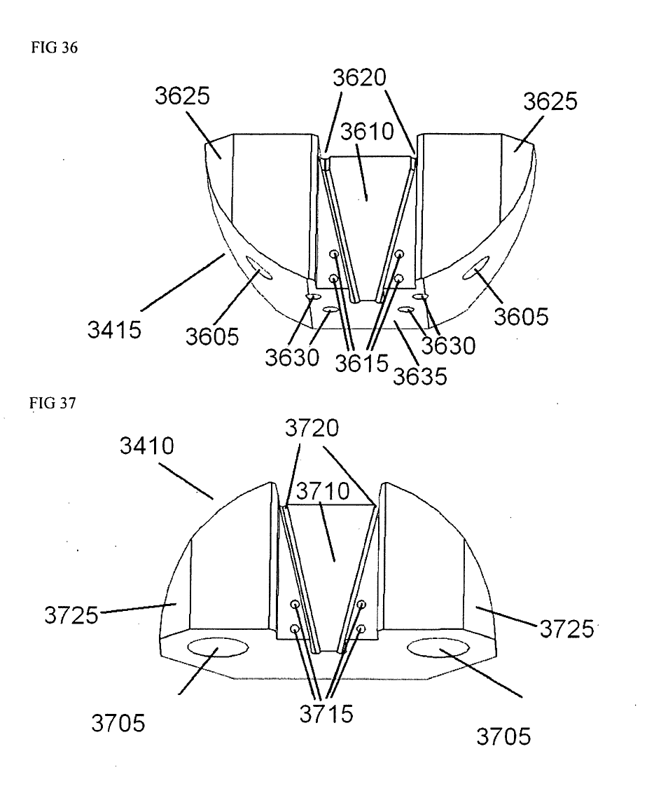

The assembly of the present embodiment of a cable pulling device 120, is depicted in FIG. 35 which shows a perspective exploded view of the embodiment depicted in FIG. 34. The embodiment comprises two hydraulic cylinders 3405, a top fixture 3410 to which the top of the cylinder(s) is/are fixedly attached by screws or bolts 3440 as shown, and a bottom fixture 3415 to which the bottom of the cylinder(s) is/are fixedly attached by screws or bolts 3440 as shown, and to which a nose piece 3420 is fixedly attached by screws or bolts 3445 as shown. The embodiment depicted additionally comprises an upper gripping assembly 3425 comprised of two gripper elements, and a lower gripper assembly 3427 comprised of two gripping elements, four bracket elements 3430 which are joined by screws or bolts 3435, two to the upper fixture 3410 and two to the lower fixture 3415, as shown. As described herein, the upper fixture 3410 and lower fixture 3415 can be easily machined from an appropriately sized cylinder of metal by cutting it in half bisecting the circle of the cylinder, and machining the half pieces in accordance with the description of FIGS. 36 and 37. Thus it can be see that an advantage of an aspect of the present invention, is the design requiring a relatively small number of machining steps from a relatively small number of pieces of stock material. One of skill in the art will recognize that various substitutions are possible without departing from the scope of the present invention. For example, the number, type and placement of the screws shown, and the use of screws to join elements is meant to be illustrative and not limiting, and one of skill in the art will recognize that components can be joined in other ways including but not limited to welding, without departing from the scope of the present invention.

The bottom fixture 3415 is shown in more detail in FIG. 36, and is comprised of a half cylinder of material with portions removed comprising screw holes 3605 for mounting the cylinders 3410 as shown in FIG. 35, a wedge shaped channel 3610 with recessed edges 3620 for holding and guiding the gripping elements 3427 as shown in FIG. 35, four screw holes 3615 for mounting the bracket elements 3430 as shown in FIG. 35, a series of facet cuts 3625 removing extra material, and rounding off some of the edges of the fixture, to reduce weight and make the device easier to handle, four screw holes 3630 for mounting the nose piece 3420 as shown in FIG. 35, and a flat facet cut 3635 at the bottom of the fixture, to further facilitate the mounting of the nose piece. Each as described herein, the bottom fixture serves to hold the assembly together, to mount the bottom end of the hydraulic cylinders, to transfer forces between the hydraulic cylinders 3410, the grippers 3427, and the nose piece 3420, and by the wedge shaped channel 3610 with recessed edges 3620, to enable in part the functioning of the grippers 3427 as described herein.

The top fixture 3410 is shown in more detail in FIG. 37, and is comprised of a half cylinder of material with portions removed comprising screw holes 3705 for mounting the cylinders 3410 as shown in FIG. 35, a wedge shaped channel 3710 with recessed edges 3720 for holding and guiding the gripping elements 3425 as shown in FIG. 35, four screw holes 3715 for mounting the bracket elements 3430 as shown in FIG. 35, and a series of facet cuts 3725 removing extra material, and rounding off some of the edges of the fixture, to reduce weight and make the device easier to handle. Each as described herein, the top fixture serves to hold the assembly together, to mount the top end of the hydraulic cylinders, to transfer forces between the hydraulic cylinders 3410, and the grippers 3425, and by the wedge shaped channel 3710 with recessed edges 3720, to enable in part the functioning of the grippers 3427 as described herein.

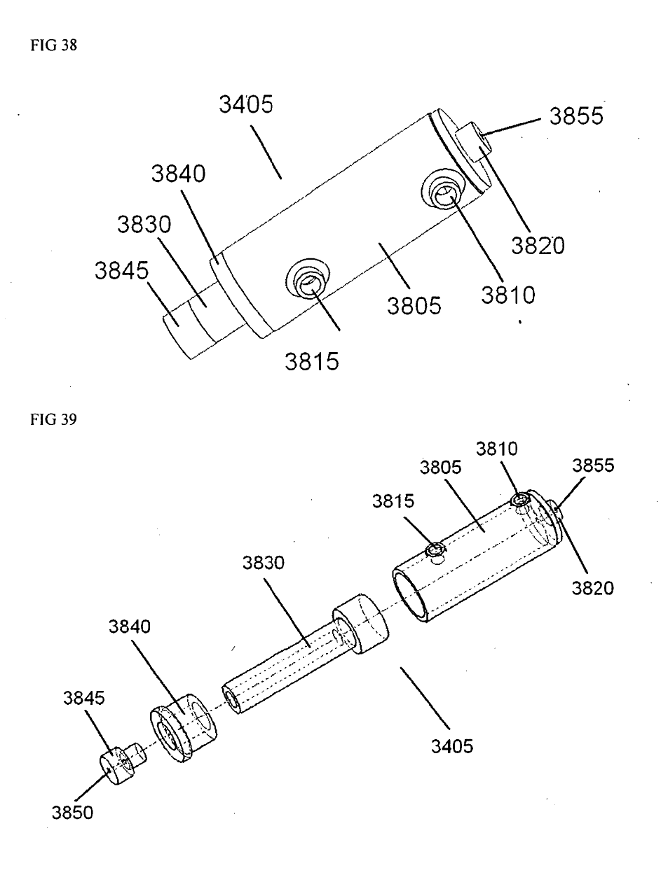

A typical hydraulic cylinder as used in the present embodiment is shown in more detail in FIGS. 38 and 39. The Cylinder comprises a cylinder outer housing portion 3805, a first hydraulic fluid port 3810 and a second hydraulic fluid port 3815, a rear mounting extrusion 3820 with mounting screw hole 3855, a hydraulic piston or rod 3830, a gland 3840 and an end piece 3845 with screw hole 3850. Such a hydraulic cylinder is activated by supplying high pressure hydraulic fluid, via a pump, to one of the ports, while accepting low pressure hydraulic fluid back into the reservoir of the hydraulic pump, from the other port. Hence in the operation of the present embodiment of the present invention, a hydraulic pump is attached via hydraulic lines to the two ports of each cylinder, in such a way that high pressure fluid is pumped into the first hydraulic fluid ports 3810 of the hydraulic cylinders 3405, while low pressure fluid returns to the reservoir of the hydraulic pump from the second hydraulic fluid ports 3815 via hydraulic lines, during the pulling stroke. During the recovery stroke these roles are reversed, and high pressure hydraulic fluid is sent from the hydraulic pump to the second hydraulic fluid port 3815, the piston retracts, and low pressure hydraulic fluid exits from the first hydraulic fluid port 3810 and returns to the fluid reservoir of the hydraulic pump.

The nose piece 3420 is shown in more detail in FIG. 40. The nose piece is generally a side-truncated cylindrical piece 4040 with a similarly truncated mounting face 4030 on one side. The cylindrical piece has cut-outs 4015 and a tapered face 4020 for locking into the annulus of the frame. The nose piece 3420 has an opening 4010 to allow for sideways insertion of the cable 70. The mounting face has screw holes for mounting the nose piece 3420 to the lower fixture 3415 at the flat facet cut 3635 at the bottom of the fixture.

It should be noted that the design show in FIGS. 34 through 40, while disclosed herein for use with a low pressure high-flow-rate hydraulic system, can also be used with a high pressure hydraulic system. One simply has to replace the cylinders with cylinders of appropriate diameter, length and specifications (such as maximum pressure and force ratings), for the job in question.

It is therefore to be understood that when hydraulic pressure is applied to the two hydraulic cylinders 3405, that the outer housing portions 3805 of the cylinders 3405 will move up relative to the piston rods 3830 and the bottom fixed element 3415. It is also to be realized that when the nose piece 3420 of the cable pulling device 120 is mounted in the annulus 124 of the frame 84, that the bottom fixed element 3415 will remain stationary while the top fixture 3410 and the two cylinder outer housings 3805 will move up. Additionally, it is to be understood that the grippers 3425 are disposed within the movable top fixture 3410, and that when the grippers 3425 move up relative to the cable 70, that the saw-tooth ridges 568 of the grippers 3425 will grab the outer surface of the cable 70 and pull it up. Finally, after the cylinder housings 3805 have traveled up to the extent of a piston stroke, the housings 3805 will return to the forward position and, significantly, the gripper ridges 568 will release their hold upon the cable and slide forwardly along the surface of the cable 70. Thus, with each repeatable, upward cable pulling stroke of perhaps six to twelve inches, depending upon the piston travel of the cable pulling device 120, the gripper ridges 568 will pull the cable 70 upwardly. Thereafter, upon the return stroke of the cable pulling device 120, the cable 70 will remain stationary while the grippers 3425 slide along its outer surface. Thus, each cable pulling stroke will pull the cable upwardly, until, ultimately, the cable with its attached pipe parting mole will be pulled entirely through the pipe 14. It should be specifically noted again that while the foregoing description has detailed the workings and mechanism as shown in the corresponding figures, one of skill in the art will recognize that various equivalents can be substituted without departure from the scope of the present invention. For example the gripper engagements described are not limited only to saw teeth. Indeed, for example (but not limited to), dots, waves and ridges also can be used to provide the same functionality. Totally smooth grips of soft steel will also perform, for example if the taper is substantially between 6 and 8 degrees and the gripper relative length is tripled.

While the embodiment depicted in FIGS. 34 and 35 is shown with two hydraulic cylinders 3405, one of skill in the art will appreciate that other configurations are possible. One embodiment is comprised of upper and lower fixtures in a similar way, and a set of more than two hydraulic cylinders, all in parallel with tops fixedly attached to the top fixture and bottoms fixedly attached to the bottom fixture. In designing such an embodiment, the cylinders are placed so that the center of force on each cylinder coincides with the center of the cable 70. For example, the mounting points at the center of each cylinder can be placed at the vertices of a regular polygon, and a path through the center of the polygon can then be taken as the path that the cable 70 follows. The grippers can be disposed near this center, so that when they grip the cable, the force is directed towards the center of the polygon. Note that the cross-sectional area of the cylinders will essentially represent a “keep out” region through which the cable can not pass (since the cylinders are there), and the designer will keep this in mind when designing multi-cylinder systems in accordance with the present invention.

Another embodiment in accordance with the present invention, shown in FIG. 41, comprises a power spool. The power spool is comprised of a powered rotating element assembly 4100 that is comprised of a bit holder 4112, and hydraulic power lines 4107 and 4105, a rod 4110 with a pointed tip 4115, a spool stand 4120 capable of being engaged and release with a pin 4125, and a cable spool 4130. In an embodiment the powered rotating element assembly 4100 is comprised of a hydraulic drill or auger, with the rod 4110 placed as the bit of the drill—in the bit holder 4112. The rod 4110 is place through the axis of the cable spool 4130, the spool stand 4120 put in place under the spool 4130, and the pin 4125 inserted to hold the spool stand 4120 and the spool 4130 in place. The pointed tip 4115 of the rod 4110 is inserted into the ground, to complete a pivot around which the spool 4130 winds and unwinds. A cable 70 is wound around the spool 4130. The power spool is used in accordance with the present invention and provides the advantages of faster setup and finish, and power-controlled cable management for a cable 70 which is connected to a puller 120 and a mole 40 or impactor 4210 in accordance with the present invention. When cable 70 is pulled in accordance with the present invention, the slack cable 70 can be wound around a spool 4130. The power spool allows this winding to be done automatically. In particular, the power spool allows for maintenance of a controlled tension on the cable 70, which provides a safety advantage by reducing the need for human operators to wind the cable 70, and controlling the cable 70, for example in the case when a cable 70 breaks, since, in such a case, energy stored elastically in the cable 70 can cause the free end of the cable 70 to whip around creating danger. In these and other cases the power spool can be used to wind and otherwise control the cable 70. The power spool can also be used to push the cable 70 through the pipe 14, prior to attaching the cable 70 to the mole 40, during setup for a pipe replacement job.

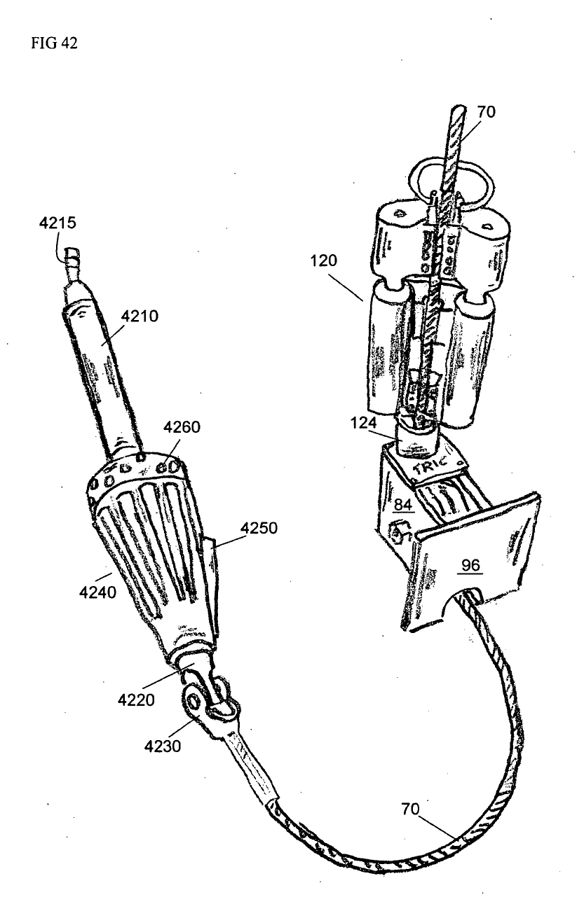

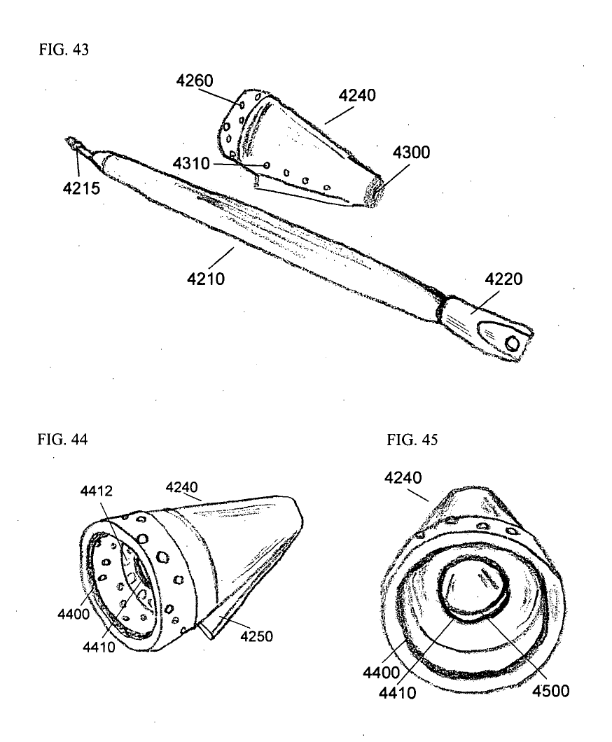

Another embodiment in accordance with the present invention, shown in FIG. 42, comprises a pipe parting mole 4240, an impactor 4210 that is engagable to the mole 4240, a length of cable 70 that is engagable to the impactor 4210, a cable pulling device 120 and a cable pulling device engagement frame 84 that provides a mounting structure for the cable pulling device 120. The cable pulling device engagement frame 84 comprises a reaction plate 96 and an annulus member 124 for removably engaging the cable pulling device 120 with the frame 84. The frame 84 is configured for the sideways engagement of the cable 70 within the frame 84 and the annulus member 124. Two pairs of cable engagement collets 560 are preferably utilized; a first pair being disposed within the cable pulling device 120 to engage the cable 70 on a pulling stroke, and a second pair may be disposed within the frame 84 or the cable pulling device 120 to engage the cable 70 on a recovery stroke. In the embodiment shown, one end of the cable 70 is fixed to a clevis 4230. The impactor 4210 has a nosepiece 4220 capable of being releasable engaged to the clevis 4230 by a clevis pin or bolt. The mole 4240 is comprised of a cutting blade 4250, which may be a permanent part of the mole 4240 or may be removable fixed to the mole 4240 by bolts or screws or other fastening methods known to those of skill in the art. The mole 4240 is also comprised of a series of mounting holes 4260, with which the new pipe 60 can be attached to the mole for trenchless pipe replacement in accordance with the present invention. The impactor 4120 is also comprised of the necessary pneumatic or hydraulic hoses or attachment(s) 4215 necessary to power the impactor. As can be seen in FIG. 42, the mole 4240 can have a hollow center (see the opening 4300 in FIG. 43) through which the impactor 4210 passes and into which the impactor is thereby releasably engaged. In other embodiments the impactor is releasably engaged to the mole 4240 by screws, bolts or screw threads on the impactor 4210 together with matching screw socket threads on the mole 4240.

FIG. 43 shows an embodiment of the mole 4240 and impactor 4210 in accordance with the present invention. The impactor 4210 comprises a power attachment 4215, and a nosepiece 4220 capable of being releasably fixed to a cable end engagement member such as a clevis (see the clevis 4130 of FIG. 42). The mole 4240 comprises a series of bolt or screw holes 4310 for releasably attaching a cutting blade 4250. The mole 4240 has a through-hole 4300, through which the impactor 4210 is passed and thereby locks into and is releasably attached to the mole 4240.

The impactor 4210 can be comprised of a piercing tool such as the Footage Tools Big Shoot (see product document), or the piercing tools described in U.S. Pat. No. 5,025,868 to Wentworth et. al. These examples of impactors are meant to be illustrative and not limiting, and one of skill in the art will see that other impactor devices can be used in accordance with the present invention.

Such a piercing tool is generally powered by compressed air (but others can, for example, be hydraulically powered), and can often be configured to run in forward and reverse modes. As known in the art (see the references cited, as well as the U.S. Provisional Patent No. 60/956,672), such piercing tools can be comprised of an internal hammer, a forward anvil and a rear anvil. The compressed air causes the hammer to move and strike the relevant anvil, causing a shock or force acting in the desired direction. As known in the art, the “Big Shoot” tool is set to run in forward mode by rotating an air tube/whip hose clock-wise as far as it will go (when looking at the rear of the tool.) This, in turn, positions the air tube sleeve for proper timing of the forward and rearward travel so that the piston will strike the front of the barrel/front anvil, and not the tailpiece anvil. The tool is set to run in reverse mode by rotating the air tube/whip hose counter-clock-wise as far as it will go (when looking at the rear of the tool.) This, in turn, positions the air tube sleeve for proper timing of the forward and rearward travel so that the piston will strike the tailpiece anvil and not the front of the barrel.

An embodiment of a bursting head or mole of the present invention, for use with an impactor is shown in FIGS. 44-46. The mole 4240 is comprised of a cutting blade 4250, and O-rings 4400, 4410 and 4500. In accordance with the present invention, these O-rings 4400, 4410 and 4500 create a watertight seal that provides advantages in that the embodiment can be used with water in the pipe to be replaced 14. Prior art uses of impactors and piercing systems relate to the creation or digging of a conduit for the placement of pipe, for example in the ground. In these methods, friction from the dirt on the outside of the piercing tool holds the tool in place as the piston cycles back, between strikes of the anvil. When the ground is wet and this friction is not present, the prior art tool becomes less effective at digging and will wobble back and forth with the motion of the piston rather than digging the desired underground hole or conduit. The O-rings 4400, 4410, 4500 in the embodiment of the present invention allow for a piercing tool or impactor that is used in conjunction with a puller 120 for combined force in bursting or cutting of pipe to comprise a method and system for trenchless replacement of underground pipe. The mole 4240 is also comprised of screw holes 4412 for the attachment of optional upsizing accessories as describe herein

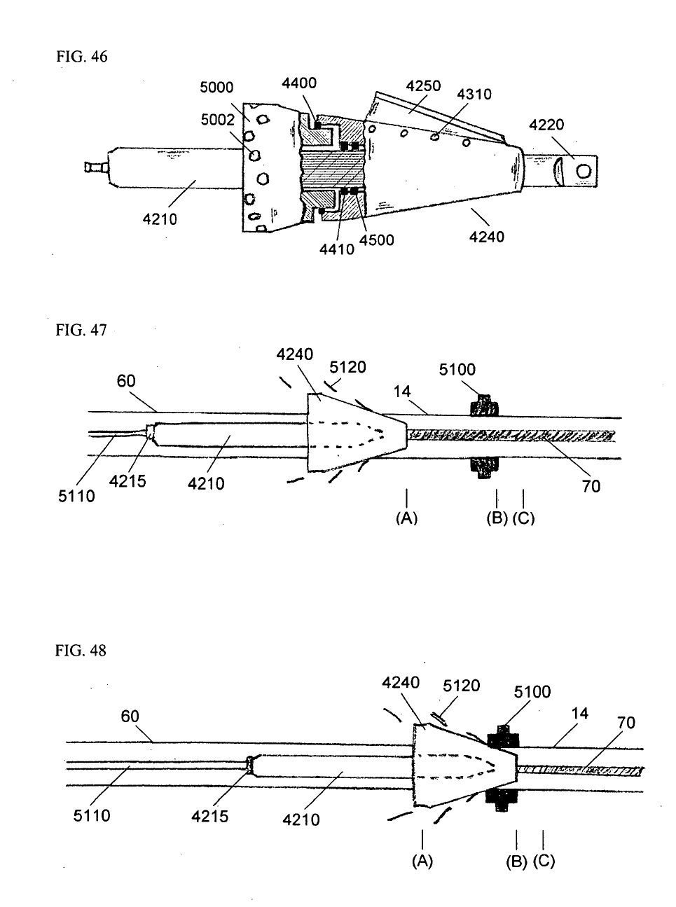

To that end, as shown in FIGS. 42-50, in combination with FIG. 1, a method and system for trenchless replacement of underground pipe comprises providing a pipe parting mole 4240 such as the one shown in FIG. 46, an impactor 4210 that is engagable to the mole 4240, a length of cable 70 that is engagable to the impactor 4210, a cable pulling device 120 and a cable pulling device engagement frame 84 that provides a mounting structure for the cable pulling device 120. The cable pulling device engagement frame 84 comprises a reaction plate 96 and an annulus member 124 for removably engaging the cable pulling device 120 with the frame 84. The frame 84 is configured for the sideways engagement of the cable 70 within the frame 84 and the annulus member 124. Two pairs of cable engagement collets 560 are preferably utilized; a first pair being disposed within the cable pulling device 120 to engage the cable 70 on a pulling stroke, and a second pair may be disposed within the frame 84 or the cable pulling device 120 to engage the cable 70 on a recovery stroke. The mole 4240 is comprised of a series of screw holes 4260, and pipe 60 can be attached to the mole 4240 for use in accordance with the present invention, using these holes. The mole 4240 comprises o-rings 4910, 4920, 4930 for water-tight operation. In addition to the method steps and system description associated with FIG. 1 herein, the present method and system comprises, optionally, the filling with water of at least one substantially intact portion of the pipe 14. Additionally, the puller 120 can be used to pull the cable 70 faster than the mole 40 advances through the pipe 14. In these ways, the combination of 4 factors goes to the pulling of the parting mole 4240 through the pipe 14 and the ground. First, the force of the puller 120. Second, the force of tension stored elastically in the cable 70 when the puller 120 pulls the cable 70 faster than the mole 40 advances. Third, the hammer effect of the impactor 4210 providing a hammer force that propels the mole 4240. Forth, the presence of liquid in the system, which acts to lubricate the pipe 14 and ground in proximity to the mole 4240. This combined system serves to liquefy the soil near the mole 4240, further improving the effectiveness of the method and system. During setup of the system for use, access is gained to the pipe to be replaced 14, cable 70 is passed through the pipe 14 either by pushing, for example with a power spool as describe herein, or, for example, by passing a guide wire through the pipe 14, and using this guide wire to pull the cable back. One end of the cable is attached to the end of a mole 40, or to an impactor 4210 which had been secured into a mole 4240, and these elements are placed near the access point at one end of the pipe 14. A frame 84, and puller 120 are setup at the access point at the other end of the pipe 14, with the reaction plate bracing the setup as described herein. A replacement pipe 60 is attached to the mole 40. When the puller 120 pulls the cable 70, the mole 40, together with the cutting blade (e.g. 4250), cuts, fractures, parts or otherwise displaces the old pope 14, and pulls in its place the replacement pipe 60. This can be used in connection with occasional or constant use of the impactor 4210 (in setups where the impactor is employed), to increase the force with which the old pipe 14 is displaced and the new pipe 60 is put in place.

FIG. 46 shows a partial break-away view of the mole 4240, together with an upsizing attachment 5000. The mole 4240 comprises a cutting blade 4250 for parting pipe, a series of holes 4310 for screwing or bolting the blade 4250 to the mole 4240, and an opening through which an impactor 4210 can be snuggly attached, in such a way that the impactor's end-member 4220 for attaching a cable clevis, protrudes through the front of the mole as shown in the figure, a series of O-rings: one O-ring 4400 for a water-tight seal with a section of new pipe, or an upsizing attachment 5000, and two O-rings 4410 and 4500 for forming a water-tight seal between the mole 4240 and the impactor 4210. The O-rings serve as described herein, forming a water-tight seal and enabling the use of the combined puller-mole-impactor system within pipes that contain water. The upsizing attachment 5000 is a round element as shown in FIG. 46, and comprises screw or bolt holes for attaching to the mole 4240, well as screw holes 5002 for attaching pipe 60. The upsizing attachment 5000 attaches to the screw-holes 4260 of the mole 4240, forms a seal with the O-ring 4400, and attaches to a larger diameter pipe via the screw holes

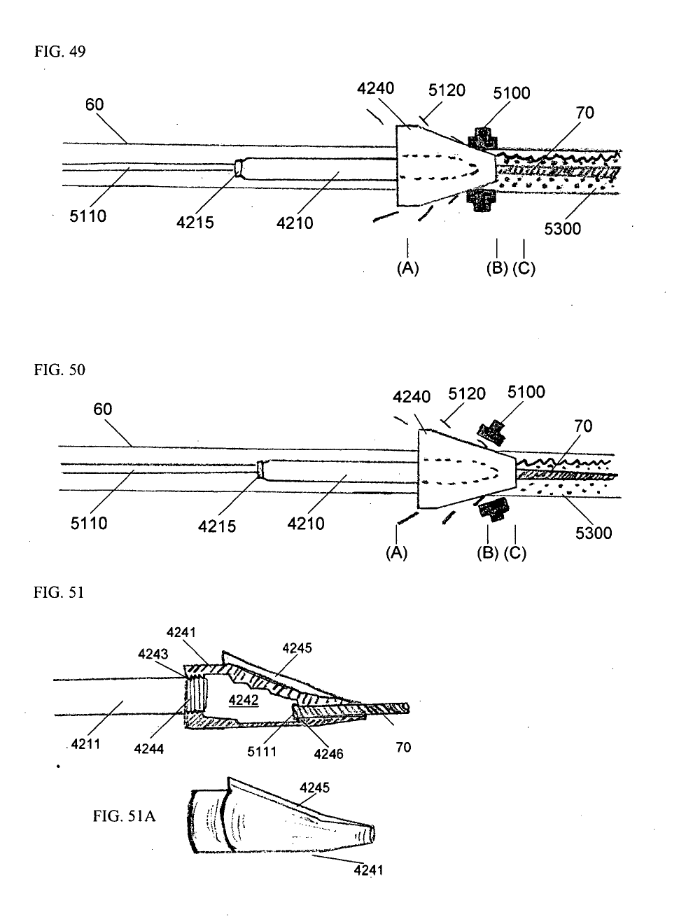

The method of use of the puller and impactor system described herein is further illustrated in FIGS. 47-50, and comprises the following. In the figures, elements of the trenchless pipe replacement system are shown comprising a cable 70 engaged to a mole 4240 and an impactor 4210, where the cable 70 is passed through a pipe 14 that is to be replaced. A compressed-air hose 5110 is passed through replacement pipe 60, and attached to the power input 4215 of the impactor 4210. The replacement pipe 60 is attached to the mole 4240. During trenchless pipe replacement, the mole 4240 moves from left to right in the diagrams. For example, in FIG. 47 the front of the mole 4240 is approximately at the position indicated by the arrow (A). Somewhere ahead of the arrow (A), at approximately the position indicated by the arrow (B), is shown a bell hub 5100. The bell hub is a pipe segment sealing means, and is more difficult to displace than ordinary sections of the pipe 14. Fragments 5120 of the displaced pipe 14 are shown. In FIG. 48 the pipe replacement has proceeded, and the mole 4240 is at the position (B). As shown in FIG. 49, water can be added into at least some intact section of the pipe 14, and will serve to lubricate the pipe 14, and liquefy the ground around the pipe fragments 5120, to decrease the force needed to pull the mole 4240 further to the right. As described herein, the o-rings 4400, 4410, and 4500 serve to protect the impactor from getting wet, and allow for operation in this wet environment. The impactor 4210 can also be activated to increase the force to the right in the figures. As shown in FIG. 50, these resultant forces cause the mole 4240 to fracture and displace the bell hub, and the pipe replacement proceeds with the mole approximately at the position shown by the arrow (C). As described herein, the present invention comprises an impactor engaged to exert forward force on the mole to accomplish trenchless pipe replacement. As described herein, the system comprises one or more o-rings engaged between the mole and the impactor to create a water-tight seal around at least a portion of the impactor, thereby improving the functionality of the impactor in the presence of water.

FIGS. 51 and 51A show another embodiment of the present invention for use, for example, in the trenchless replacement of steel pipe. Shown are a mole 4241 comprised of a cutting blade 4245, an internal space 4242 with threads 4243 on one end for engagement to an impactor 4211, and an internal lip 4246 on the other end, for engagement with a stop-swage cable end 5111, at one end of a cable 70. The impactor 4211 can be, but is not limited to, a pneumatic hammer such as comprises the impactors described herein, and has threads on its front end 4244, for engagement into the threads 4243 of the mole.

While the compressed-air power coupling 4215 if the impactors 4210 described herein are shown as compressed-air hoses, one of skill in the art will see that other arrangements are possible. For example, in one embodiment the replacement pipe 60 can be used as the compressed-air conduit for powering the impactor 4210 or 4211.

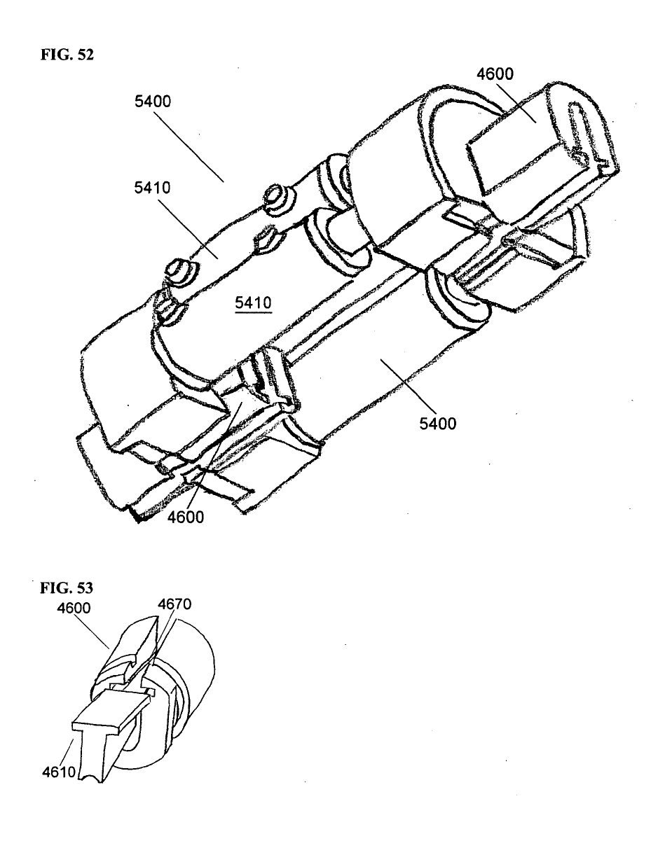

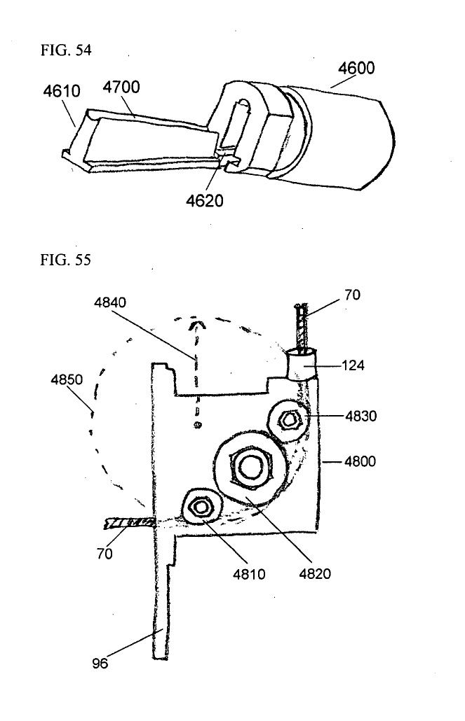

FIG. 52 shows a 4 cylinder puller incorporating single sided grippers shown in more detail in FIGS. 53 and 54. An aspect of the single sided grippers is that the bridge assembly must be made large on bigger rams (i.e. those designed for many tons of pull). These are difficult and expensive to manufacture. Indeed the largest commercially available machining tools are required to manufacture these elements without the single sided gripper. The design shown in FIG. 53 enables, for example, a device with up to about 400 tons of pull in a tool just a few feet tall.

FIG. 55 shows an alternative embodiment in accordance with the present invention, of a reaction plate and pulley assembly having multiple rollers. It is desirable when pulling a cable to not bend the cable at a radius tighter than a manufacturer specified minimum bend radius. In practicing the present invention, a cable is pulled through an angle of approximately 90 degrees (but can be more or less depending on the tilt of the puller body in the pulley assembly). In the pulley assembly shown in FIGS. 12-15, the bend radius to which the cable is subjected is the radius of the cable pulley 740. As shown in FIG. 54, by providing a series of 3 cable pulleys of different size, paced internal to and substantially tangent to the circular dashed line, a cable pulling path approximating the circular arc of the dash line is achieved in a space smaller than would be required to achieve the same circular path by the pulley assembly shown in FIGS. 12-15. For example, a roughly 90 degree bend can be achieved in a path approximating a circular arc with a 30″ radius, in an 18″ space.

While the present invention has been shown and described with regard to its preferred embodiments, it will be understood by those skilled in the art that alterations and modifications in form and detail may be made therein without departing from the true spirit and scope of the invention. It is therefore intended that the following claims cover all such alterations and modifications that encompass the true spirit and scope of the invention.

What we claim is:

1. A device for the trenchless replacement of in-situ pipe, comprising:
a mole;
a length of cable, said cable being engagable to said mole;
a cable pulling device;
a cable pulling device mounting frame being releasably engagable to said cable pulling device
wherein said cable pulling device mounting frame includes an annulus member including a cable passage bore formed therethrough and a cable insertion slot formed through portions of said annulus member for the sideways insertion of said cable within said cable passage bore of said annulus member and
wherein said annulus member includes a cable pulling device engagement portion for releasably engaging a portion of said cable pulling device.

2. A device as described in claim 1 further comprising an impactor; wherein said impactor is engaged to exert forward force on said mole.

3. The device of claim 2, further comprising a first o-ring wherein said o-ring is engaged between said mole and said impactor to create a water-tight seal around at least a portion of said impactor, thereby improving the functionality of said impactor in the presence of water.
